(19) United States
(12) Patent Application Publication
(10) Pub. No.: US 2024/0397480 A1
(43) Pub. Date: Nov. 28, 2024

(54) INTELLIGENT PAGING

(71) Applicant: TELEFONAKTIEBOLAGET LM ERICSSON (PUBL), Stockholm (SE)

(72) Inventors: Chao XU, Shanghai (CN); Tianyi LI, Shanghai (CN); Kun YANG, Shanghai (CN)

(21) Appl. No.: 18/687,718

(22) PCT Filed: Aug. 31, 2022
(86) PCT No.: PCT/CN2022/116087

§ 371 Date: Feb. 28, 2024

(30) Foreign Application Priority Data
Sep. 1, 2021 (WO) PCT/CN2021/115895

(51) Int. Cl. H04W 68/02; H04W 24/02

(52) U.S. Cl. CPC H04W 68/02; H04W 24/02

(57) ABSTRACT

The present disclosure is related to intelligent paging. A method at a first network node for facilitating a second network node in paging a UE comprises: collecting, from one or more network nodes, paging information for the UE; determining an ML model at least partially based on the paging information; and transmitting, to the second network node, the determined ML model and/or a configuration that is derived from the ML model for use by the second network node in paging the UE.

### CROSS-REFERENCE TO RELATED APPLICATION(S)

This application claims priority to the PCT International Application No. PCT/CN2021/115895, entitled “INTELLIGENT PAGING”, filed on Sep. 1, 2021, which is incorporated herein by reference in its entirety.

### TECHNICAL FIELD

The present disclosure is related to the field of telecommunications, and in particular, to methods and network nodes for intelligent paging.

### BACKGROUND

Nowadays, people will use their mobile devices (e.g., a mobile phone, a tablet, etc.) for their study, work, and/or entertainment every day. The most popular radio access technologies (RATs) used by the mobile devices comprise: 4G Long Term Evolution (LTE), 5G New Radio (NR), or the like. Among numerous technologies employed by 4G or 5G, paging is obviously one of the most important technologies.

Paging is the mechanism in which a network notifies its user equipment (UE) of downlink data arrival or any other event related to the UE. Then, the UE may decode the content (e.g. Paging Cause) of the paging message and the UE has to initiate an appropriate procedure, for example, a random access procedure. Paging, also referred to as the Network-Initiated Service Request, is used for signaling between a UE and the network when the UE is in the IDLE state. The operator can configure the Paging procedure to reduce the number of paging messages, which in turn can contribute to reduction in the network load. By reducing the number of paging messages, fewer resources are allocated to the network. The available resources can be used for handling more users. Less paging also reduces the signaling in the radio access network. Therefore, a solution for achieving a better tradeoff between less paging signaling and a lower paging delay is required.

### SUMMARY

According to a first aspect of the present disclosure, a method at a first network node for facilitating a second network node in paging a UE is provided. The method comprises that paging information for the UE is collected from one or more network nodes. The method further comprises that a machine learning (ML) model is determined at least partially based on the paging information. The method further comprises the determined ML model and/or a configuration that is derived from the ML model is transmitted to the second network node for use by the second network node in paging the UE.

In some embodiments, the first network node is a Network Data Analytics Function (NWDAF) that is collocated with at least one of: a Mobility Management Entity (MME), an Access and Mobility Function (AMF), a Core Network (CN) node, a Radio Access Network (RAN) node, a Packet Core Controller (PCC), a Packet Core Gateway (PCG), an Operation Supporting System (OSS), a Cloud Core Exposure Server (CCES), a Multi-access Edge Computing (MEC) node, and an O-RAN node. In some embodiments, the NWDAF is deployed as a service in a standalone Application Development Platform (ADP) at a PCC, and the second network node is the MME or the AMF. In some embodiments, the step of collecting, from one or more network nodes, paging information for the UE comprises that paging information for the UE is received from a collocated mobility management module. In some embodiments, the paging information comprises at least one of: location information in terms of tracking area (TA), eNB/gNB, or cell, time information, and UE service type.

In some embodiments, the method further comprises that optimization proposal information for optimizing a paging profile for the UE is transmitted to a network management system. In some embodiments, the NWDAF is deployed as a custom application in a Service Management & Orchestration (SMO) framework at an O-RAN node, and the second network node is a Non-Real Time RAN Intelligent Controller (Non-RT RIC). In some embodiments, the A1 interface of the O-RAN node is used for exchanging Artificial Intelligence (AI)/ML information and/or information for data analytics. In some embodiments, the ML model is trained at the Non-Real Time RIC of the O-RAN node, and the trained ML model is passed from the Non-Real Time RIC to the Near-Real Time RIC via the A1 interface. In some embodiments, the ML model is trained for extracting at least one of: network user-level traffic space-time distribution, user mobility characteristics and/or models, user service types and/or models, and user experience prediction models.

In some embodiments, the first network node is an AI server that is located separately from the second network node. In some embodiments, the collected information is anonymized. In some embodiments, the paging information comprises at least one of: mobility information for one or more UEs comprising the UE, statistical paging information for the one or more UEs, core network information for a core network to which the first network node belongs, and supplemental information. In some embodiments, the statistical paging information comprises at least one of: a paging success ratio in each paging phase, a number of paging messages in each paging phase, and paging attempts in each paging phase. In some embodiments, the core network information comprises relationship between each TA and eNB/gNB. In some embodiments, the supplemental information comprises information that facilitates the MME or AMF in linking the ML model to an Operation and Maintenance (OAM) configuration.

In some embodiments, the step of determining the ML model for the UE comprises that mobility information for the UE is analyzed. The step of determining the ML model for the UE further comprises that statistical paging information is evaluated to simulate paging at one or more confidence levels. The step of determining the ML model for the UE further comprises that the ML model for the UE is determined at least partially based on the analyzed mobility information and/or the evaluated statistical paging information. In some embodiments, an initial configuration of the ML model is configured by an OAM module. In some embodiments, the method further comprises that the OAM module may be provided with at least one of history of confidence levels, performance of the current paging procedure, and suggestion for paging profiles.

In some embodiments, the step of determining the ML model for the UE at least partially based on the paging information comprises that the ML model is trained based on a cost function that is determined at least partially based on an amount of signaling for successfully paging the UE and/or a paging latency. In some embodiments, the cost function is calculated as follows:

$$TotalCost = G ( latency ) ⊗ F ( signal )$$

where TotalCost is the cost to be calculated, G(latency) is a function with an input argument of latency, F(signal) is a function with an input argument of amount of signaling, and “⊗” is an operator for calculating an inner product of its operands.

In some embodiments, the i^{th} element of G(latency) is calculated as follows:

$${G ( latency )}_{i} = λ ( i ) {e}^{{G ( latency )}_{i}^{K}}$$

where i indicates the i^{th} paging, λ(i) is a regularization factor for balancing paging latency and amount of signaling, and K>1 and K∈ [symbol] .

In some embodiments, the i^{th} element of G(latency) is calculated as follows:

$${G ( latency )}_{l} = λ ( i ) {e}^{i - 1}$$

$$or$$

$${G ( latency )}_{i} = λ ( i ) {N}^{i - 1}$$

where N>1 and N∈ [symbol] .

In some embodiments, the jth element of F(signal) is calculated as follows:

$${F ( signal )}_{j} = {failurerate ( j - 1 , t , conf )}_{j} * {( P a g i n g S i g n a ls ( j , t , conf ) )}_{j}$$

$${failurerate ( 0 , t , conf )}_{1} = 1$$

where j indicates the jth paging, failurerate (j−1, t, conf)ⱼ is the paging failure rate for the j−1^{th} paging at a given time t and a given confidence level of conf, PagingSignals(j, t, conf) is the amount of signaling for the j^{th} paging at the given time t and the given confidence level of conf.

In some embodiments, the step of training the ML model based on the cost function comprises that a current confidence level is determined at least partially based on a previous confidence level, one or more candidate confidence levels that are different from the previous confidence level, a previous cost associated with the previous confidence level for the previous training interval, and one or more estimated costs associated with the one or more candidate confidence levels for the previous training interval. The step of training the ML model based on the cost function comprises that the ML model is trained based on the cost function at the current confidence level and the estimated cost at the one or more candidate confidence levels.

In some embodiments, the step of determining the current confidence level comprises that the previous cost is compared with the one or more estimated costs. The step of determining the current confidence level comprises that the current confidence level is determined as one of the previous confidence level and the one or more candidate confidence levels that has the lowest cost.

In some embodiments, an extremum value of F(signal) is determined by solving a partial differential equation as follows:

$${F}^{′} ( conf ) = {\sum }_{i = 1}^{N} \frac{\partial {F}_{i} ( f a i l u r e r a t e ( i - 1 , t , c o n {f}_{i} )}{\partial c o n {f}_{i}}$$

where i>0, and

$$\frac{\partial {F}_{i} ( failurerate ( i - 1 , t , {conf}_{i} )}{\partial c o n {f}_{i}}$$

indicates a partial derivative of Fᵢ(failurerate (i−1, t, confᵢ) with respect to the variable confᵢ.

In some embodiments, an extremum value of F(signal) is determined by solving a partial differential equation as follows:

$${F}^{′} ( conf ) = \frac{\partial {F}_{j} ( f a i l u r e r a te ( j - 1 , t , c o n {f}_{j} )}{\partial c o n {f}_{j}} {F}_{i} ( failurerate ( i - 1 , t , {conf}_{i} ) ) + \frac{\partial {F}_{i} ( f a i l u r e r a t e ( i - 1 , t , c o n {f}_{i} )}{\partial c o n {f}_{i}} {F}_{j} ( failurerate ( j - 1 , t , {conf}_{j} ) ) + …$$

where i≠j≠0, i, j>0, and

$$\frac{\partial {F}_{i} ( failurerate ( i - 1 , t , {conf}_{i} )}{\partial c o n {f}_{i}}$$

indicates a partial derivative of Fᵢ(failurerate (i−1, t, confᵢ) with respect to the variable confᵢ.

According to a second aspect of the present disclosure, a first network node is provided. The first network node comprises a processor and a memory storing instructions which, when executed by the processor, cause the processor to perform the method of any of the first aspect.

According to a third aspect of the present disclosure, a first network node for facilitating a second network node in paging a UE is provided. The first network node comprises a collecting module for collecting paging information for the UE from one or more network nodes, a determining module for determining an ML model at least partially based on the paging information, and a transmitting module for transmitting the determined ML model and/or a configuration that is derived from the ML model to the second network node for use by the second network node in paging the UE.

According to a fourth aspect of the present disclosure, a method at a second network node for paging a UE is provided. The method comprises that an ML model and/or a configuration that is derived from the ML model is received from a first network node for paging the UE. The method further comprises a paging profile is determined at least partially based on the received ML model and/or configuration. The method further comprises a paging procedure for the UE is initiated at least partially based on the determined paging profile.

In some embodiments, the first network node is an NWDAF that is collocated with the second network node, and the second network node is at least one of: an MME; an AMF, a CN node, a RAN node, a PCC, a PCG, an OSS, a CCES, a MEC node, and an O-RAN node. In some embodiments, the second network node is deployed as a mobility management module at a PCC. In some embodiments, the method further comprises that paging information for the UE is transmitted to the collocated NWDAF. In some embodiments, the paging information comprises at least one of: location information in terms of TA, eNB/gNB, or cell, time information, and UE type.

In some embodiments, the method further comprises that a paging profile for updating the paging profile stored at the second network node is received from a network management system. In some embodiments, the NWDAF is deployed as a custom application in an SMO framework at an O-RAN node, and the second network node is a Near-Real Time RIC. In some embodiments, the A1 interface of the O-RAN node is used for exchanging AI/ML information and/or information for data analytics. In some embodiments, the ML model is trained at the Non-Real Time RIC of the O-RAN node, and the trained ML model is passed from the Non-Real Time RIC to the Near-Real

Time RIC via the A1 interface. In some embodiments, the ML model is trained for extracting at least one of: network user-level traffic space-time distribution, user mobility characteristics and/or models, user service types and/or models, and user experience prediction models. In some embodiments, the NWDAF is deployed as an application or service on a MEC platform at a MEC host or collocated with a MEC orchestrator, and the second network node is a UPF. In some embodiments, the first network node is an AI server that is located separately from the second network node.

According to a fifth aspect of the present disclosure, a second network node is provided. The second network node comprises a processor and a memory storing instructions which, when executed by the processor, cause the processor to perform the method of any of the fourth aspect.

According to a sixth aspect of the present disclosure, a second network node for paging a UE is provided. The second network node comprises: a receiving module for receiving, from a first network node, an ML model and/or a configuration that is derived from the ML model, for paging the UE, a determining module for determining a paging profile at least partially based on the received ML model and/or configuration, and an initiating module for initiating a paging procedure for the UE at least partially based on the determined paging profile.

According to a seventh aspect of the present disclosure, a computer program comprising instructions is provided. The instructions, when executed by at least one processor, cause the at least one processor to carry out the method of any of the first aspect and/or the fourth aspect.

According to an eighth aspect of the present disclosure, a carrier containing the computer program of the seventh aspect is provided. In some embodiments, the carrier is one of an electronic signal, optical signal, radio signal, or computer readable storage medium.

According to a ninth aspect of the present disclosure, a telecommunications system is provided. The telecommunications system comprises one or more UEs, a first network node of the second and/or third aspect, and a second network node of the fifth and/or sixth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a block diagram illustrating an exemplary telecommunications network in which intelligent paging according to an embodiment of the present disclosure may be applicable.

FIG. 2 is a block diagram illustrating an exemplary environment in which an NWDAF according to an embodiment of the present disclosure may be operable.

FIG. 3 shows exemplary flowcharts for service procedures that can be consumed or provided by an NWDAF according to an embodiment of the present disclosure.

FIG. 4 is a block diagram illustrating an exemplary mapping from NWDAF use cases to 5G Core (5GC) with which intelligent paging according to an embodiment of the present disclosure may be applicable.

FIG. 5 is an exemplary histogram illustrating a probability distribution for different events that may cause paging in a network.

FIG. 6 is a block diagram illustrating an exemplary architecture of a PCC with which an NWDAF is collocated according to an embodiment of the present disclosure.

FIG. 7 is a block diagram illustrating an exemplary service architecture of a PCC with which an NWDAF is collocated according to an embodiment of the present disclosure.

FIG. 8 is a block diagram illustrating an exemplary software architecture of a PCC with which an NWDAF is collocated according to an embodiment of the present disclosure.

FIG. 9 shows block diagrams illustrating multiple types of NWDAF, which are collocated with different functional entities, according to embodiments of the present disclosure.

FIG. 10 is a block diagram illustrating an exemplary O-RAN architecture in which an NWDAF according to an embodiment of the present disclosure may be operable.

FIG. 11 is a block diagram illustrating an exemplary improved O-RAN architecture in which an NWDAF according to an embodiment of the present disclosure may be operable.

FIG. 12 is a block diagram illustrating an exemplary edging computing architecture in which an NWDAF according to an embodiment of the present disclosure may be operable.

FIG. 13 is a diagram illustrating an exemplary cost distribution over time for intelligent paging according to an embodiment of the present disclosure.

FIG. 14 is a diagram illustrating an exemplary cost distribution at different confidence levels for intelligent paging according to an embodiment of the present disclosure.

FIG. 15 is a diagram illustrating exemplary average lengths of eNB list vs. confidence levels according to an embodiment of the present disclosure.

FIG. 16 is a diagram illustrating an exemplary auto-tuning scheme for intelligent paging according to an embodiment of the present disclosure.

FIG. 17 is a diagram illustrating performance of an exemplary auto-tuning scheme for intelligent paging with different initial confidence levels according to an embodiment of the present disclosure

FIG. 18 is a diagram illustrating an exemplary auto-tuning scheme for intelligent paging with a reduced complexity according to an embodiment of the present disclosure

FIG. 19 is a block diagram illustrating exemplary intelligent paging in an offline mode according to an embodiment of the present disclosure.

FIG. 20 is a diagram illustrating an exemplary procedure for AMF using NWDAF outputs to optimize UE mobility according to an embodiment of the present disclosure.

FIG. 21 is a flow chart of an exemplary method at a first network node for facilitating a second network node in paging a UE according to an embodiment of the present disclosure.

FIG. 22 is a flow chart of an exemplary method at a second network node for paging a UE according to an embodiment of the present disclosure.

FIG. 23 schematically shows an embodiment of an arrangement which may be used in an NWDAF and/or an AMF/MME according to an embodiment of the present disclosure.

FIG. 24 is a block diagram of an exemplary first network node according to an embodiment of the present disclosure.

FIG. 25 is a block diagram of an exemplary second network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (NR), the present disclosure is not limited thereto. In fact, as long as support for paging is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), 5G NR, etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, a network node, or any other equivalents. Further, the term “node” used herein may refer to a UE, a functional entity, a network entity, a network element, a network equipment, or any other equivalents.

Further, following 3GPP documents are incorporated herein by reference in their entireties:
3GPP TS 23.288 V17.0.0 (2021-03), 3rd Generation Partnership Project; Technical Specification Group Services and System Aspects; Architecture enhancements for 5G System (5GS) to support network data analytics services (Release 17);
3GPP TS 23.501 V17.0.0 (2021-03), 3rd Generation Partnership Project; Technical Specification Group Services and System Aspects; System architecture for the 5G System (5GS); Stage 2 (Release 17); and
3GPP TS 29.520 V17.3.0 (2021-06), 3rd Generation Partnership Project; Technical Specification Group Core Network and Terminals; 5G System; Network Data Analytics Services; Stage 3 (Release 17).

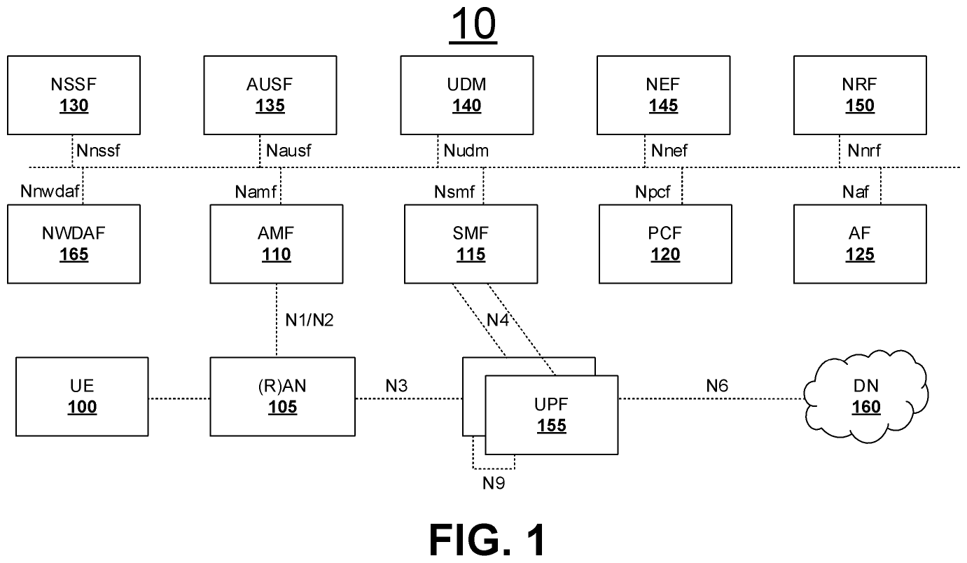

FIG. 1 is a block diagram illustrating an exemplary telecommunications network 10 in which intelligent paging according to an embodiment of the present disclosure may be applicable. Although the telecommunications network 10 is a network defined in the context of 5G NR, the present disclosure is not limited thereto.

As shown in FIG. 1, the network 10 may comprise one or more UEs 100 and a (radio) access network ((R)AN) 105, which could be a base station, a Node B, an evolved NodeB (eNB), a gNB, or an AN node which provides the UEs 100 with access to other parts of the network 10. Further, the network 10 may comprise its core network portion comprising (but not limited to) an AMF 110, a Session Management Function (SMF) 115, a Policy Control Function (PCF) 120, an Application Function (AF) 125, a Network Slice Selection Function (NSSF) 130, an Authentication Server Function (AUSF) 135, a Unified Data Management (UDM) 140, a Network Exposure Function (NEF) 145, a Network Repository Function (NRF) 150, one or more User Plane Functions (UPFs) 155, and a Network Data Analytics Function (NWDAF) 165. As shown in FIG. 1, these entities may communicate with each other via the service-based interfaces, such as, Namf, Nsmf, Npcf, etc. and/or the reference points, such as, N1, N2, N3, N4, N6, N9, etc.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions (e.g., mobility management entity (MME)) may be different from those shown in FIG. 1 (e.g., the AMF 110). For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

Here, some of the functions shown in FIG. 1, such as AMF 110, SMF 115, UPFs 155, NWDAF 165, which may be involved in the embodiments of the present disclosure will be described in detail below.

Referring to FIG. 1, the AMF 110 may provide most of the functions that the MME provides in a 4G network as mentioned above. Below please find a brief list of some of its functions:
Terminates the RAN CP interface (N2);
Non-access stratum (NAS) signaling;
NAS ciphering and integrity protection;
Mobility Management (MM) layer NAS termination;
Session Management (SM) layer NAS forwarding;
Authenticates UE;
Manages the security context;
Registration management;
Connection management;
Reachability management;
Mobility Management; and
Apply mobility related policies from PCF (e.g. mobility restrictions).

Further, the SMF 115 may provide the session management functions that are handled by the 4G MME, Secure Gateway-Control plane (SGW-C), and PDN Gateway-Control plane (PGW-C). Below please find a brief list of some of its functions:
Allocates IP addresses to UES;
NAS signaling for session management (SM);
Sends Quality of Service (QOS) and policy information to RAN via the AMF;
Downlink data notification;
Select and control UPF for traffic routing;
Acts as the interface for all communication related to offered user plane services; and
Lawful intercept-control plane. Further, the UPFs 155 is essentially a fusion of the data plane parts of the SGW and PGW. In the context of the Control User Plane Separation (CUPS) architecture: Evolved Packet Core (EPC) SGW-U+EPC PGW-U→5G UPF.

The UPFs 155 may perform the following functions:
Packet routing and forwarding
Packet inspection and QoS handling, and the UPF may optionally integrate a

Deep Packet Inspection (DPI) for packet inspection and classification;
Connecting to the Internet POP (Point of Presence), and the UPF may optionally integrate the Firewall and Network Address Translation (NAT) functions;
Mobility anchor for Intra RAT and Inter-RAT handovers;
Lawful intercept-user plane; and
Maintains and reports traffic statistics.

As shown in FIG. 1, the UPFs 155 are communicatively connected to the Data Network (DN) 160 which may be, or in turn communicatively connected to, the Internet, such that the UEs 100 may finally communicate its user plane data with other devices outside the network 10, for example, via the RAN 105 and the UPFs 155.

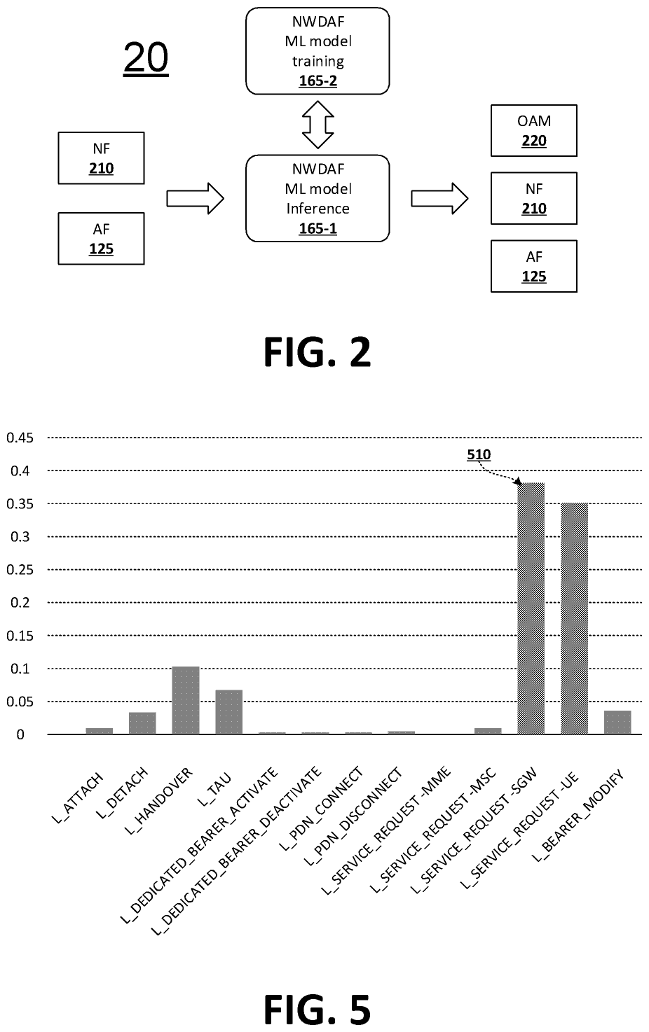

Further, the functions of the NWDAF 165 will be described with reference to FIG. 2 in details.

FIG. 2 is a block diagram illustrating an exemplary environment 20 in which the NWDAF 165 according to an embodiment of the present disclosure may be operable. As defined by 3GPP technical specifications, for example, TS 23.501, TS 23.288, TS 29.520, the NWDAF 165 may provide analytics services to 5GC NFs 210, AFs 125, and OAM 220. In some embodiments, analytics may be either statistical information from the past or predictive information for the future.

As shown in FIG. 2, the NWDAF 165 may train an ML model based on data collected from other NFs 210 (for example, the AMF 110, the SMF 115, the PCF 120, etc.) and/or one or more AFs 125, potentially in connection with other data (e.g., data from the OAM 220), as indicated by the block 165-2. With the trained ML model, the NWDAF 165 may provide services (e.g., predicted locations of UEs) to the NFs 210, AFs 125, and/or the OAM 220.

According to Analytics Use Cases defined in TS 23.288, the NWDAF 165 may have following related service experience use cases for Rel-16 and Rel-17, respectively.

TABLE 1
Services (use cases) for NWDAF Rel-16

| NWDAF Service | Description |
|---|---|
| Slice Load level | Requested Analytics data, including load level |
| information | information of Network Slice instance(s). |
| Observed Service | Observed Service experience may be provided, |
| experience | individually per UE or clustered per UE subsets |
| information | in the case of group of UEs, or globally, |
| | averaged per Application or averaged across a |
| | set of Applications on a Network Slice. |
| NF Load | Load statistics or predictions information for |
| information | specific NF(s). |
| Network | Statistics or predictions on the load in an |
| Performance | Area of Interest; in addition, statistics or |
| information | predictions on the number of UEs that are |
| | located in that Area of Interest. |
| UE mobility | Statistics or predictions on UE mobility. |
| information | |
| UE Communication | Statistics or predictions on UE communication. |
| information | |
| Expected UE | Analytics on UE Mobility and/or UE |
| behavioural | Communication. |
| parameters | |
| UE Abnormal | The exception with an appropriate exception ID. |
| behaviour | |
| information | |
| User Data | Statistics or predictions on the user data |
| Congestion | congestion for transfer over the user plane, |
| information | for transfer over the control plane, or for both. |
| QoS | For statistics, the information on the location |
| Sustainability | and the time for the QoS change and the |
| | threshold(s) that were crossed; or, for predictions, |
| | the information on the location and the time when |
| | a potential QoS change may occur and what |
| | threshold(s) may be crossed. |

TABLE 2
Services (use cases) for NWDAF Rel-17

| # | NWDAF service |
|---|---|
| 1 | NWDAF-assisted RAT/frequency selection |
| 2 | NWDAF supporting detection of anomaly events and helping in |
| | analysing its cause |
| 3 | NWDAF support for dispersion analytics |
| 4 | Analytics Assisted Smart City Applications |
| 5 | NWDAF supporting the detection of cyber-attacks. |
| 6 | Supporting edge computing |
| 7 | Real-time data collection and analytics delivery by NWDAF |

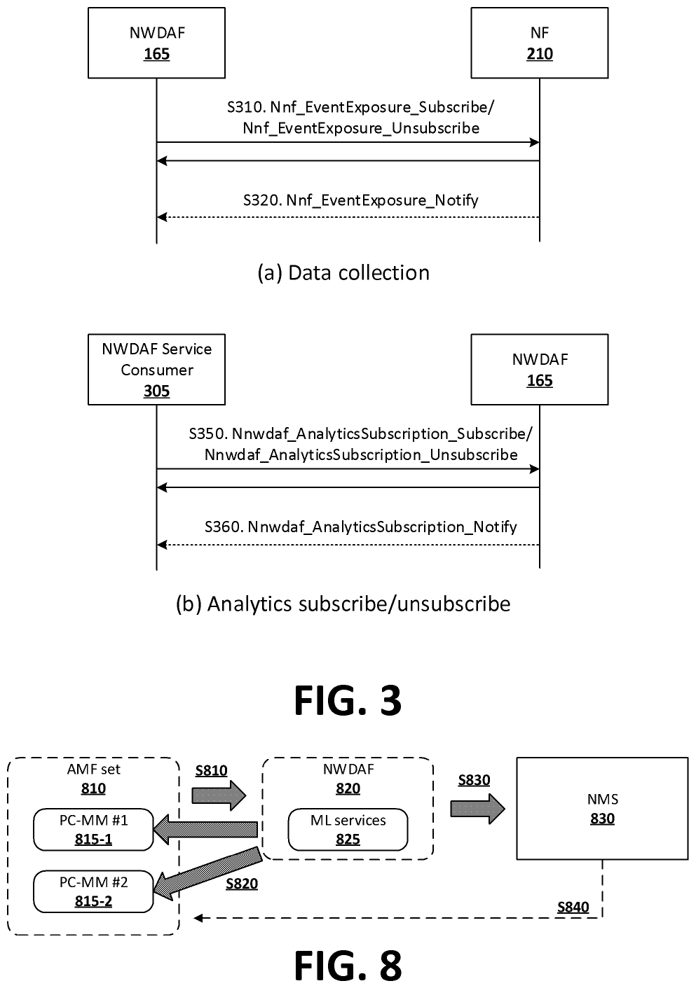

FIG. 3 shows exemplary flowcharts for service procedures that can be consumed or provided by the NWDAF 165 according to an embodiment of the present disclosure.

The procedure shown in (a) of FIG. 3 may be used or consumed by the NWDAF 165 to subscribe/unsubscribe at NFs 210 in order to be notified for data collection on a related event(s), for example, using Event Exposure Services as listed in Table 6.2.2.1-1 in 3GPP TS 23.288. At step S310, the NWDAF 165 may subscribe to or cancel subscription for a (set of) Event ID(s) by invoking the Nnf_EventExposure_Subscribe/Nnf_EventExposure_Unsubscribe service operation. At step S320, if the NWDAF 165 subscribes to a (set of) Event ID(s), the NFs 210 may notify the NWDAF 165 (e.g. with the event report) by invoking Nnf_EventExposure_Notify service operation. In some embodiments, the NWDAF 165 can use the immediate reporting flag to meet the request-response model for data collection from NFs. Further, in some embodiments, this procedure may also be used when the NWDAF 165 subscribes for data from a trusted AF.

The procedure shown in (b) of FIG. 3 may be used or consumed by any NWDAF service consumer 305 (e.g. the AF 125/the NFs 210/the OAM 220) to subscribe/unsubscribe at the NWDAF 165 to be notified on analytics information, using Nnwdaf_AnalyticsSubscription service. This service may also be used by an NWDAF service consumer 305 to modify existing analytics subscription(s). Any entity can consume this service. At step S350, the NWDAF service consumer 305 may subscribe to or cancel subscription to analytics information by invoking the Nnwdaf_AnalyticsSubscription_Subscribe/Nnwdaf_AnalyticsSubscription_Unsubscribe service operation. When a subscription to analytics information is received, the NWDAF 165 may determine whether triggering new data collection is needed. If the service invocation is for a subscription modification, the NWDAF service consumer 305 may include an identifier (Subscription Correlation ID) to be modified in the invocation of Nnwdaf_AnalyticsSubscription_Subscribe. At step S360, if the NWDAF service consumer 305 subscribes to analytics information, the NWDAF 165 may notify the NWDAF service consumer 305 with the analytics information by invoking Nnwdaf_AnalyticsSubscription_Notify service operation, based on the request from the NWDAF service consumer 305, e.g. Analytics Reporting Parameters.

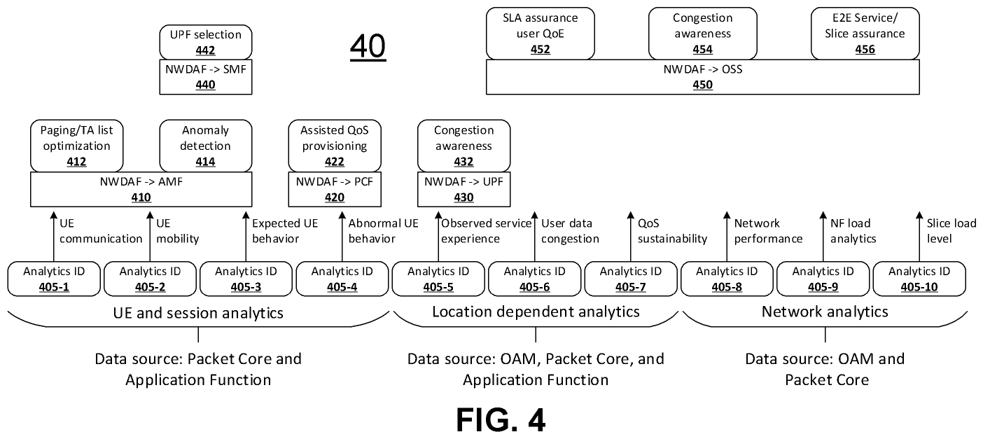

FIG. 4 is a block diagram illustrating an exemplary mapping 40 from NWDAF use cases to 5GC with which intelligent paging according to an embodiment of the present disclosure may be applicable. As shown in FIG. 4, the NWDAF 165 may collect different types of data from different sources, such as packet core (e.g., the AMF 110), application functions (the AF 125), and/or OAM (the OAM 220). The collected data may comprise (but not limited to) at least one of UE communication data 405-1, UE mobility data 405-2, expected UE behavior data 405-3, abnormal UE behavior data 405-4, observed service experience data 405-5, user data congestion data 405-6, QoS sustainability data 405-7, network performance data 405-8, NF load analytics data 405-9, and slice load level data 405-10.

The NWDAF 165 may analyze the collected data and generate statistical information or predictive information based thereon (for example, as shown in FIG. 2), and provide the information to other entities. For example, the NWDAF 165 may provide its analytics data to the AMF 110 as indicated by the block 410, for example, for the purpose of paging/TA list optimization as indicated by the block 412 (which will be described in detail below) or for the purpose of anomaly detection as indicated by the block 414. Similarly, the NWDAF 165 may provide the analytics information to the SMF 115 for UPF selection 442, to the PCF 420 for assisted QoS provisioning 422, to the UPF 430 for congestion awareness 432, to the OSS (e.g., the OAM 220) 450 for Service Level Agreement (SLA) assurance and user Quality of Experience (QoE) 452, congestion awareness 454, and/or End-to-End (E2E) service/slice assurance 456.

As indicated by the reference numeral 412, TS 23.288 defines an ideal specification of UE mobility prediction procedure and data structure including input data and output analytics. As defined, NWDAF supporting UE mobility statistics or predictions shall be able to collect UE mobility related information from NF, OAM, and to perform data analytics to provide UE mobility statistics or predictions.

The service consumer may be an NF (e.g. AMF, SMF).

The consumer of these analytics may indicate in the request at least one of:
The Target of Analytics Reporting, which could be a single UE or a group of UEs.
Analytics Filter Information optionally containing:
   Area of Interest;

NOTE: For Local Area Data Network (LADN) service, the consumer (e.g. SMF 115) may provide the LADN Data Network Name (DNN) to refer the LADN service area as the

Area of Interest.
An Analytics target period indicates the time period over which the statistics or predictions are requested.
Optionally, maximum number of objects.
Preferred level of accuracy of the analytics.
Preferred order of results for the time slot entries: ascending or descending time slot start;
In a subscription, the Notification Correlation Id and the Notification Target Address are included.

The NWDAF supporting data analytics on UE mobility shall be able to collect UE mobility information from OAM, 5GC and AFs. The detailed information collected by the NWDAF could be Minimization of Drive Tests (MDT) data from OAM, network data from 5GC and/or service data from AFs, for example:
UE mobility information from OAM is UE location carried in MDT data;
Network data related to UE mobility from 5GC is UE location information as defined in the Table 3 below;

TABLE 3
UE Mobility information collected from 5GC

| Information | Source | Description |
|---|---|---|
| UE ID | AMF | SUPI |
| UE locations | AMF | UE positions |
| (1 . . . max) | | |
| >UE location | | TA or cells that the UE enters (NOTE 1) |
| >Timestamp | | A time stamp when the AMF detects the |
| | | UE enters this location |
| Type Allocation | AMF | To indicate the terminal model and vendor |
| code (TAC) | | information of the UE. The UEs with the |
| | | same TAC may have similar mobility |
| | | behaviour. The UE whose mobility |
| | | behaviour is unlike other UEs with the |
| | | same TAC may be an abnormal one. |
| Frequent | AMF | A UE (e.g. a stationary UE) may re-select |
| Mobility | | between neighbour cells due to radio |
| Registration | | coverage fluctuations. This may lead to |
| Update | | multiple Mobility Registration Updates if |
| | | the cells belong to different registration |
| | | areas. The number of Mobility Registration |
| | | Updates N within a period M may be an |
| | | indication for abnormal ping-pong |
| | | behaviour, where N and M are operator's |
| | | configurable parameters. |

NOTE 1:
UE location includes either the last known location or the current location, under the conditions defined in Table 4.15.3.1-1 in TS 23.502 [3].

Service data related to UE mobility provided by AFs is defined in the Table 4below;

TABLE 4
Service Data from AF related to UE mobility

| Information | Description |
|---|---|
| UE ID | Could be external UE ID (i.e. GPSI) |
| Application ID | Identifying the application providing this information |
| UE trajectory | Timestamped UE positions |
| (1 . . . max) | |
| >UE location | Geographical area that the UE enters |
| >Timestamp | A time stamp when UE enters this area |

Depending on the requested level of accuracy, data collection may be provided on samples (e.g. spatial subsets of UEs or UE group, temporal subsets of UE location information).

The NWDAF supporting data analytics on UE mobility shall be able to provide UE mobility analytics to consumer NFs or AFs. The analytics results provided by the NWDAF could be UE mobility statistics as defined in table 5 below, UE mobility predictions as defined in Table 6 below:

TABLE 5
UE mobility statistics

| Information | Description |
|---|---|
| UE group ID | Identifies a UE or a group of UEs, e.g. internal |
| or UE ID | group ID defined in TS 23.501 [2] clause 5.9.7, |
| | SUPI (see NOTE). |
| Time slot entry | List of time slots during the Analytics target |
| (1 . . . max) | period |
| >Time slot start | Time slot start within the Analytics target period |
| >Duration | Duration of the time slot |
| >UE location | Observed location statistics |
| (1 . . . max) | |
| >>UE location | TA or cells which the UE stays |
| >>Ratio | Percentage of UEs in the group (in the case of |
| | an UE group) |

TABLE 6
UE mobility predictions

| Information | Description |
|---|---|
| UE group ID | Identifies an UE or a group of UEs, e.g. internal |
| or UE ID | group ID defined in TS 23.501 [2] clause 5.9.7, |
| | or SUPI (see NOTE). |
| Time slot entry | List of predicted time slots |
| (1 . . . max) | |
| >Time slot start | Time slot start time within the Analytics target |
| | period |
| >Duration | Duration of the time slot |
| >UE location | Predicted location prediction during the Analytics |
| (1 . . . max) | target period |
| >>UE location | TA or cells where the UE or UE group may move into |
| >>Confidence | Confidence of this prediction |
| >>Ratio | Percentage of UEs in the group (in the case of an |
| | UE group) |

Please note that when target of analytics reporting is an individual UE, one UE ID (i.e. Subscription Permanent Identifier (SUPI)) will be included, the NWDAF will provide the analytics mobility result (i.e. list of (predicted) time slots) to NF service consumer(s) for the UE.

The results for UE groups address the group globally. The ratio is the proportion of UEs in the group at a given location at a given time.

The number of time slots and UE locations is limited by the maximum number of objects provided as part of Analytics Reporting Information.

The time slots shall be provided by order of time, possibly overlapping. The locations shall be provided by decreasing value of ratio for a given time slot. The sum of all ratios on a given time slot must be equal to or less than 100%. Depending on the list size limitation, the least probable locations on a given Analytics target period may not be provided.

However, 3GPP TS 23.288 only proposes a UE mobility/location based analytics use case that may not satisfy operators' requirements in commercial network. Further, there are lack of some key evolution steps to be figured out that from 3GPP standard NWDAF analytics to a packet core product solution (such as, PCC), including Prove of Concept (POC), Prototype Verification, First Feature Implementation (FFI), Commercialized, etc. Further, although TS 23.288 proposes NWDAF instance(s) can be collocated with a 5GS NF, there is no clear description on collocated solution, let alone software architecture. Furthermore, from operators' commercial network OPEX reduction requirements, there is still space for improving smart paging, Machine Learning Enhanced Adaptive Paging and so on. All of these problems are related to NWDAF use cases that cannot be solved.

FIG. 5 is an exemplary histogram illustrating a probability distribution for different events that may cause paging in a network. As can be seen from FIG. 5, service requests from SGW indicated by the reference numeral 510 are a major cause for paging signaling.

Further, the current tool for optimizing paging/TA list is too heavy. For example, a complete optimization cycle is too long (e.g., 1 month at least), involving collecting event-based monitoring (EBM) data, anonymizing the data, analyzing EBM locations, running simulations, obtaining results, and verifying results on customer's nodes.

Therefore, some embodiments of the present disclosure may provide productized and standardized 5G AI/ML paging solutions (hereinafter, which are sometimes referred to as “intelligent paging”) in which automatic training and self-learning parameters optimization may be achieved. Additionally, some embodiments of the present disclosure may define an optimized cost function, and a related extremum value issue may be resolved by a self-learning convergence method in commercial network and field trial. Furthermore, some embodiments of the present disclosure may provide a polymorphic NWDAF architecture in different product forms for all types of paging deployment scenarios. The automation data collection and data processing tools in product may facilitate the whole procedure above.

With these embodiments, a realizable automatic ML paging profile training and optimization method for FFI phase may be provided. With these embodiments, paging messages cost may be reduced and paging related location convergence may be accelerated on operators' commercial network level. With these embodiments, templated ML algorithm and modeling may be performed, which may improve reusability of the ML model across different NFs, product platforms, 4G/5G, etc. With these embodiments, data (such as EBM data) collection and data processing complexity may be simplified and the system cost may be reduced. With these embodiments, the operating expense (OPEX) may be expected to be significantly reduced in both deploying and optimizing ML paging in live network. Further, polymorphic NWDAF product form (collocated or standalone) evolution and roadmap may be proposed in some embodiments, especially on AMF (PCC), OSS/network management system, O-RAN, and standalone NWDAF.

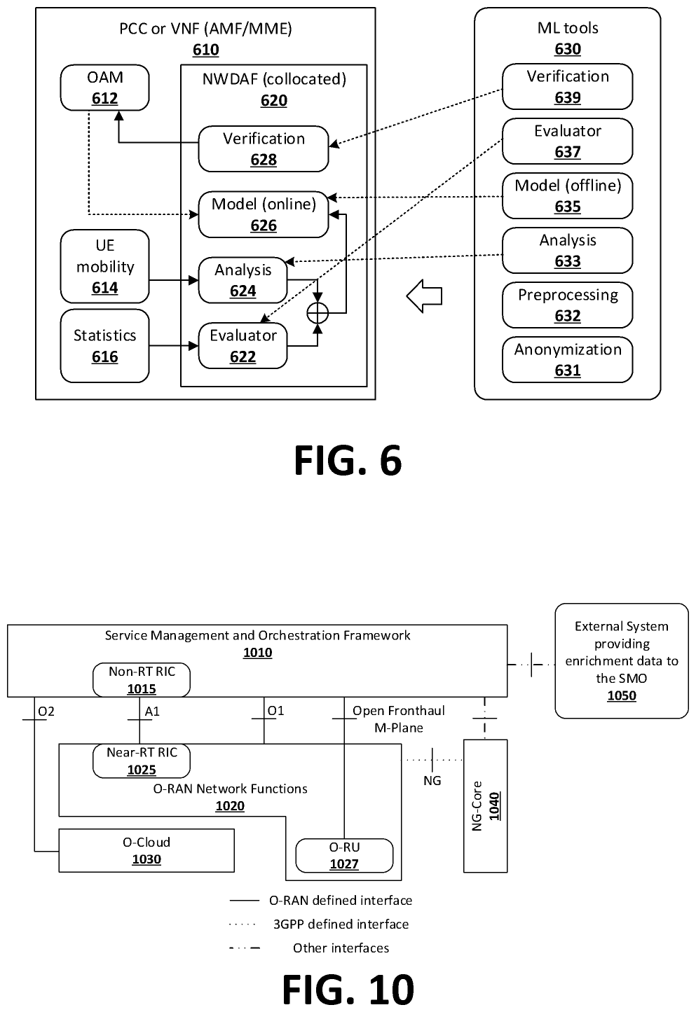

Next, a detailed description of some embodiments of intelligent paging will be given with reference to FIG. 6 to FIG. 25.

FIG. 6 is a block diagram illustrating an exemplary architecture of a PCC with which an NWDAF 620 is collocated according to an embodiment of the present disclosure. As shown in FIG. 6, the NWDAF 620 may be collocated with or within a PCC or VNF 610 that may host an AMF/MME function thereon as well. However, the present disclosure is not limited thereto. In some other embodiments, the NWDAF 620 may be collocated with or separated from other network functions or other entities.

Referring to FIG. 6, the PCC/VNF 610 may comprise several modules including but not limited to an OAM module 612, a UE mobility module 614 (e.g., a UE mobility module of the collocated AMF), a statistics module 616, and the collocated NWDAF 620. The statistics module 616 may contain basic parameters which are directly needed by cost function that will be described in details below (e.g. paging success ratios, number of paging messages, paging attempts in each paging phases), core network information (e.g. a relationship between each TA and eNB/gNB) and/or supplemental information which could help the PCC/VNF 610 to link a paging model with OAM configuration (e.g. UE type, QoS Class Identifier (QCI), and/or others).

As shown in FIG. 6, the NWDAF 620 may comprise but not limited to one or more modules, such as, an evaluator 622, an analysis module 624, a(n) (online) model 626, and a verification module 628.

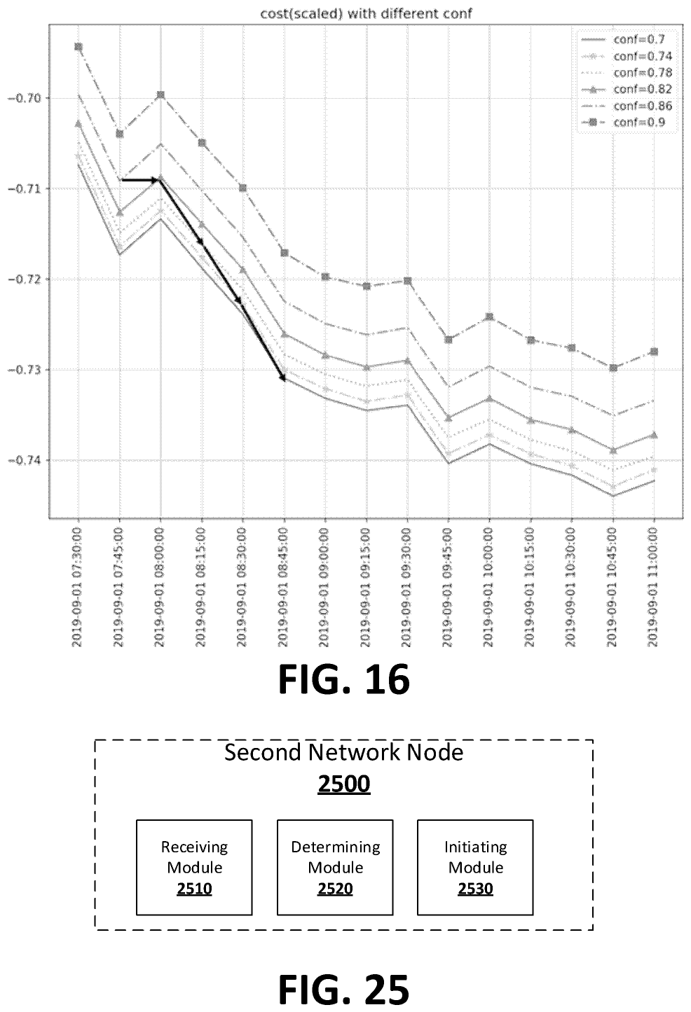

In some embodiments, the evaluator 622 may be used for auto tuning of the online model 626. The evaluator 622 may simulate paging with other confidence candidates which are not current in use, as will be described with reference to FIG. 16. This is because, in order to derive the gradient of the cost function, the PCC/VNF 610 may need to calculate the cost function for at least two confidence levels, current one and another confidence candidate. For current confidence in use, parameters (paging success ratio, number of paging message, and/or others) needed by the cost function could be directly obtained from the PCC/VNF 610. However for the candidate confidence level, these parameters need to be evaluated and estimated. For example, by assuming current confidence level in use is 0.7 and the paging could not succeed, the PCC/VNF 610 has to perform TA paging to find UE. In this case, what the evaluator 622 does is to try simulating paging with confidence 0.72 (which is different from the current value of 0.7) and evaluating whether it could success. After several rounds of evaluation, the PCC/VNFs 611 could decide whether increasing/decreasing current confidence level or not, to achieve a better paging performance (e.g., a lower cost).

In some embodiments, the analysis module 624 may analyze UE mobility data to determine the cost for the current confidence level, and the evaluator 622 may determine the costs for other confidence candidates. By comparing and combining the output of the analysis module 624 and the evaluator 622, the PCC/VNF 610 may decide how to adjust the online model 626, for example, by increasing/decreasing/unchanging its confidence levels, for example, when generating a paging/TA list for a specific UE.

In some embodiments, the online model 626 may predict one or more locations for a UE to be paged, for example, when a paging procedure is triggered by the PCC/VNF 610. In other words, the PCC/VNF 610 may query the online model 626 for the UE's possible locations. However, the present disclosure is not limited thereto. In some other embodiments, the online model 626 may update the possible locations for the UE periodically or not in response to the request from the PCC/VNF 610, such that whenever the PCC/VNF 610 wants to find the UE, it may use the predicted locations for paging the UE that is previously generated.

In some embodiments, the OAM module 612 may provide the model 626 with initial values for machine learning paging to start with, as indicated by the dashed arrow between the OAM 612 and the model 626. For example, the initial values may comprise, but not limited to, the initial confidence level used for paging, initial paging profile used for UE, or the like. Further, as mentioned above, there is an auto-tuning process for the model 626. In some embodiments, the auto tuning process needs to provide feedback to the OAM 612 timely. In some embodiments, the feedback may comprise information like the history of confidence level (e.g., to show how the model is changed from the initial configuration), performance of current paging (e.g., the success ratio, the number of paging messages), a suggestion for paging profiles (e.g., for time critical paging profile, like VOLTE call, only a suggestion is given without actually and directly changing the initial configuration since a network operator may have different opinions on these paging profiles).

Alternatively or additionally, an offline version of the NWDAF 620 may be provided as ML tools 630 shown in FIG. 6. The ML tools 630 may comprise an anonymization module 631, a preprocessing module 632, an analysis module 633, a(n) (offline) model 635, an evaluator 637, and a verification module 639. As indicated by the dashed arrows between the PCC/VNF 610 and the ML tools 630, the analysis module 633, the offline model 635, the evaluator 637, and the verification module 639 may function in a similar manner to the analysis module 624, the online model 626, the evaluator 622, and the verification module 628, and therefore the detailed description thereof is omitted for simplicity.

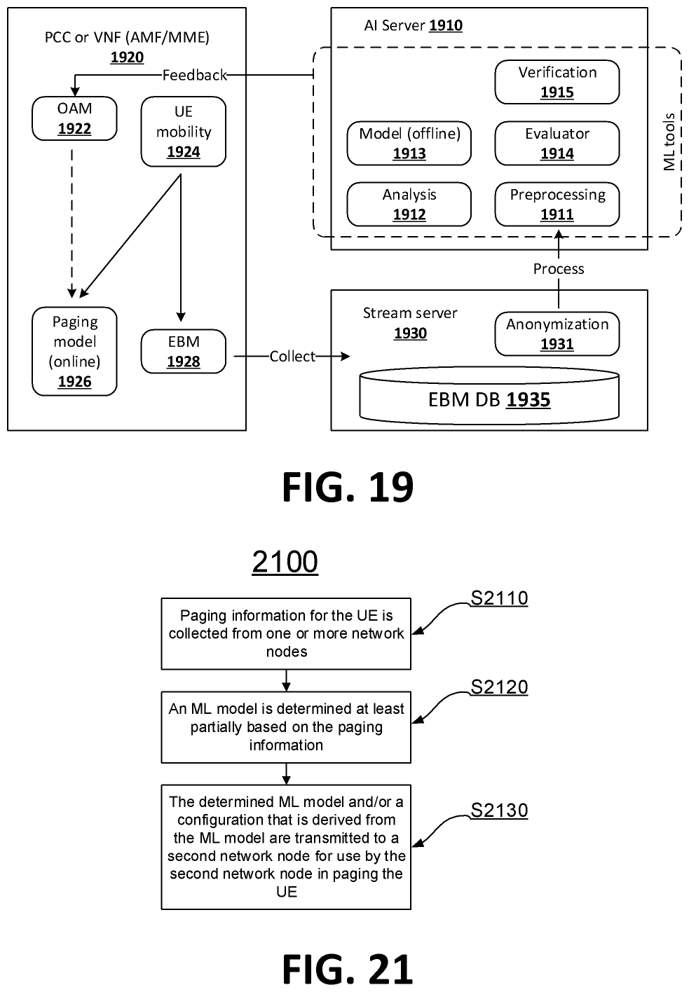

As shown in FIG. 6, the anonymization module 631 may be an optional module that is used for anonymizing data collected in the operator's domain, such that sensitive information will not be leaked to an untrusted third party. In some countries, there are laws and/or regulations to prohibit sensitive data (e.g., citizen IDs, phone numbers, locations, etc.) from being leaked to any party other than the telecommunications operators. In such a case, the anonymization module 631 is necessary. In some embodiments, the anonymization module 631 may be separately located from other modules, for example, as shown in FIG. 19. For example, to guarantee a maximum safety of the data, the network operators may require the data to be anonymized by the operators themselves, and therefore the anonymization module 631 may be provided at the premise of the operators. In some other embodiments where the data is not that sensitive, the anonymization module 631 may be located at a premise of a trusted 3^{rd} party.

As also shown in FIG. 6, the preprocessing module 632 may be used for pre-processing the collected data, for example, data format conversion, outlier data removal, or the like. In some embodiments, different data may be preprocessed in different manners.

Both of the online and offline models may have their own pros and cons. For the online model 626 that is comprised in the NWDAF 620, several modules (e.g., the anonymization module 631, the preprocessing module 632) may be omitted for cost saving, since the online model 626 is located in the operator's domain, and therefore it may achieve a faster and a safer optimization cycle for updating paging profiles. This is especially useful when mobility patterns of UEs are changing dramatically in a short period. For the offline model 630, since it does not have to react in real time or near real time, it may process a larger amount of data and/or more types of data than its online version, and therefore may determine a more accurate model for predicting UE's locations. Further, the offline model 630 may be applicable to the legacy PCC/VNF in the existing networks, and therefore may reduce costs for hardware updating to some extent.

Nevertheless, with the online and/or offline models, the PCC/VNF 610 may determine predicted locations of a UE to be paged, and therefore may achieve an optimized tradeoff between the amount of signaling and the paging delay.

Machine learning (ML) is an artificial intelligence technique that uses big data to improve the behavior of systems. ML-enhanced adaptive paging may allow an MME/AMF to identify the most likely locations of a UE that is moving in its idle mode, for example, by using a statistical analysis of the historical mobility data. With this function, UEs which have changed their locations while in idle mode can be located by the MME/AMF using a probabilistic eNB/gNB list. Therefore, locating these UEs by using this method is faster, and more paging efficient, than by using conventional methods, for example, as defined in 3GPP specifications.

In some embodiments, the configurable and adaptive paging feature may allow MME/AMF paging based on the selected paging profile, which may specify a number of paging attempts that are performed with a certain paging width. Depending on the paging profile configuration, the MME/AMF may perform paging attempts in the following four paging widths:
Last visited eNB/gNB;
eNB/gNB list: latest visited eNB//gNB list or probabilistic eNB/gNB list;
Last visited TA; and
Whole TAI list.

The probabilistic eNB/gNB list paging is an enhancement to the eNB/gNB list paging mechanism in the configurable and adaptive paging feature. If the MME/AMF uses an eNB/gNB list for paging, the MME/AMF may either make paging attempts based on the latest visited eNB/gNB list or the probabilistic eNB/gNB list. If paging based on the probabilistic eNB/gNB list is enabled, the MME/AMF may only make paging attempts based on the probabilistic eNB/gNB list. If paging based on the probabilistic eNB/gNB list is not enabled, the MME/AMF may only make paging attempts based on the latest visited eNB/gNB list.

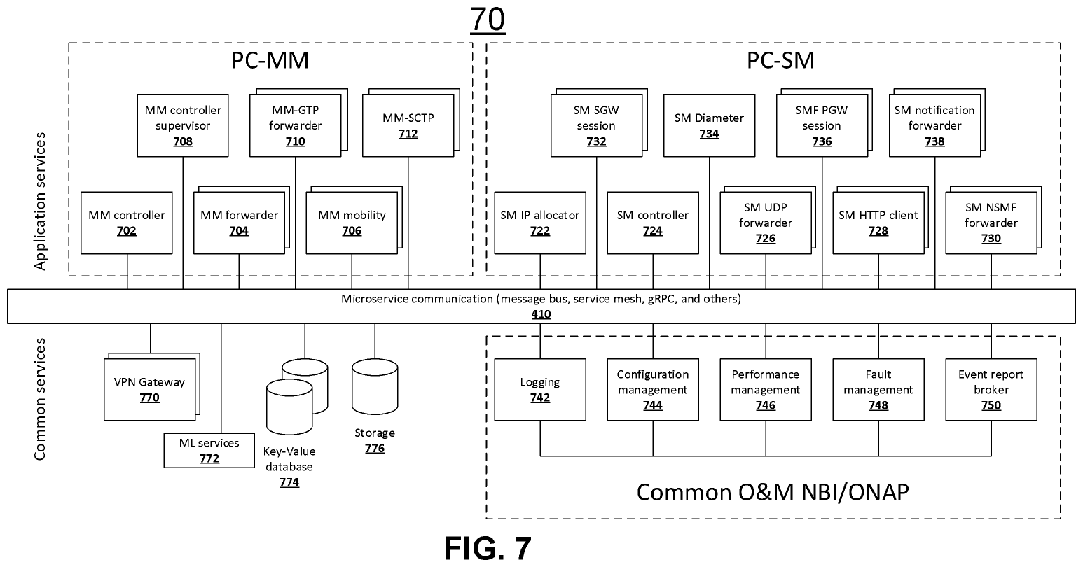

Next, a detailed implementation of the NWDAF that is collocated with a PCC will be described with reference to FIG. 7. FIG. 7 is a block diagram illustrating an exemplary service architecture of a PCC 70 with which an NWDAF is collocated according to an embodiment of the present disclosure.

As shown in FIG. 7, the PCC 70 may comprise multiple modules, for example, one or more modules for Packet Core-Mobility Management (PC-MM), one or more modules for PC-Session Management (PC-SM), one or more modules for common Operation & Management (O&M) northbound interface (NBI)/open network automation platform (ONAP), one or more modules for other services (e.g., ML services provided by the collocated NWDAF). Because the PC-MM, PC-SM, and the common O&M NBI/ONAP are not related directly to the collocated NWDAF or the ML services provided therein, the detailed description thereof is omitted for simplicity. However, it is clear for one skilled in the art to contemplate a detailed implementation of the PCC 70 with an NWDAF collocated therein from the teaching of the present disclosure.

As shown in FIG. 7, the NWDAF may provide ML services 772 in a standalone container, for example, as a new Application Development Platform (ADP) port. In some embodiments, the ML services 772 may function in a similar manner to those shown in FIG. 6 (e.g., the evaluator 622, the analysis module 624, the online model 626, and/or the verification module 628), and therefore the detailed description thereof may be omitted for simplicity.

In some embodiments, the interface of the new container may comply with TS 29.520/23.791. In some embodiments, the PCC 70 may support HTTP2 REST API in this phase.

FIG. 8 is a block diagram illustrating an exemplary software architecture of a PCC (e.g., the PCC 70 shown in FIG. 7) with which an NWDAF 820 (e.g., the NWDAF described above with reference to FIG. 7) is collocated according to an embodiment of the present disclosure. As shown in FIG. 8, an AMF set 810 may comprise one or more PC-MM instances 815-1 and 815-2 (hereinafter, collectively “the PC-MM instances 815”).

In some embodiments, each of the PC-MM instances may be instantiated for a network slice. For example, the PC-MM #1 815-1 may be instantiated for a network slice for Ultra Reliable Low Latency Communications (URLLC), while the PC-MM #2 815-2 may be instantiated for a network slice for massive Machine Type Communications (mMTC). However, the present disclosure is not limited thereto. In some other embodiments, the

AMF set 810 may comprise a single PC-MM instance or more than two PC-MM instances. In some other embodiments, at least one of the network slices may be allocated for different scenarios.

The NWDAF 820 may be deployed as standalone services 772 as shown in FIG. 7, which are also shown in FIG. 8 as ML services 825. As shown in FIG. 8, the NWDAF 820 may collect mobility data from one or more of the PC-MM instances 815 in the AMF set 810 at step S810. For example, the NWDAF 820 may subscribe mobility data of UEs from the AMF set 810, for example, as described with reference to (a) in FIG. 3 or by an internal mechanism within the PCC 70 (for example, a remote procedure call between virtual machines (VMs)). In some embodiments, the mobility data may comprise information such as UE's location (e.g., a TA, an eNB ID, and/or a cell id), timestamps, UE type, or the like.

At step S820, the ML services 825 may calculate the predicted locations based on the ML model and provide the predicted locations of a UE to at least one of the PC-MM instances 815 in the AMF set 810 whenever a paging procedure is to be initiated for the UE. In some other embodiments, the ML services 825 may update the ML model based on the data collected at step S810, and provide at least one of the PC-MM instances 815 with the updated model at step S820, such that the at least one PC-MM instance 815 may use the latest model to predict locations of UEs by themselves.

At step S830, the ML services 825 may report optimization proposal information to the NMS 830. For example, the ML services 825 may provide a proposal to the NMS 830 to change the current confidence level used by the ML services 825. Further, the NMS 830 may additionally query the NWDAF 820 for its running stats.

At step S840, the NMS 830 may optionally provide the optimized paging profile/model to the AMF set 810. In some embodiments, the ML services 825 may directly deploy the model to the PC-MM instances 815. Alternatively or additionally, the model may be deployed manually by the network operator via the optional step S840, for example, when the network operator considers it necessary to update the current model used by the AMF set 810.

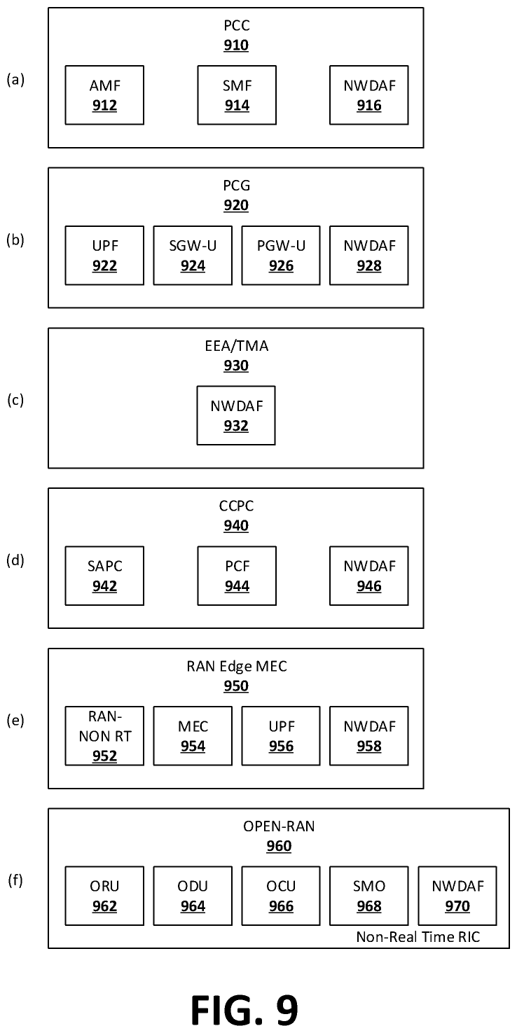

FIG. 9 shows block diagrams illustrating multiple types of NWDAF, which are collocated with different functional entities, according to embodiments of the present disclosure. As shown in FIG. 9, an NWDAF may be collocated with a number of different NFs, a number of different OAM nodes, and/or a number of different AFs, or any combination thereof.

Several embodiments of the NWDAF are shown in FIG. 9 comprising:
(a) an NWDAF 916 collocated within a PCC 910 with an AMF 912 and an SMF 914, for example, the PCC/VNF 610 shown in FIG. 6;
(b) an NWDAF 928 collocated within a Packet Core Gateway (PCG) 920 with a UPF 922, an SGW-U 924, and a PGW-U 926;
(c) an NWDAF 932 collocated within an Ericsson Expert Analytics (EEA)/Traffic Monitoring and Analysis (TMA) 930;
(d) an NWDAF 946 collocated within a Cloud Core Exposure Server (CCES) 940 with a Service-Aware Policy Controller (SAPC) 942 and a PCF 944;
(e) an NWDAF 958 collocated within a RAN Edge MEC system 950 with a RAN-Non RT part 952, an MEC node 954, and a UPF 956; and
(f) an NWDAF 970 collocated within an Open-RAN system 960 with an O1-managed Radio Unit (ORU) 962, an O1-managed Distributed Unit (ODU) 964, an O1-managed Central Unit (OCU) 966, and an SMO 968.

Please note that the present disclosure is not limited to the above listed configurations. In some other embodiments, an NWDAF may be collocated with other NFS, AFs, OAMs, other entities, or any combination thereof. Further, although some proprietary modules (e.g., EEA 930) are described, the present disclosure is not limited thereto. In some other embodiments, an entity with similar functions may be used to replace the proprietary modules. Next, some specific examples of the collocation will be described with reference to FIG. 10 to FIG. 12.

FIG. 10 is a block diagram illustrating an exemplary O-RAN architecture in which an NWDAF according to an embodiment of the present disclosure may be operable. As shown in FIG. 10, the O-RAN architecture may consist of NFs 1020, a Service Management and Orchestration framework (SMO) 1010 to manage the NFs 1020 and an O-Cloud (O-RAN Cloud) 1030 to host the network functions.

FIG. 10 shows that the four key interfaces-namely, A1, O1, Open Fronthaul M-plane, and O2-connect the SMO 1010 to O-RAN NFs 1020 and the O-Cloud 1030. It also illustrates that the O-RAN NFs 1020 can be VNFs, i.e., VMs or Containers, sitting above the O-Cloud 1030 and/or PNFs (Physical Network Function) utilizing customized hardware. All O-RAN network functions 1020 except the O-RU 1027 are expected to support the O1 interface when interfacing to the SMO 1010. In some embodiments, referring to FIG. 10 with reference to (f) of FIG. 9, the NWDAF 970 may be one of the NFs 1020 managed by the SMO 968/1010. In some embodiments, the NWDAF may be hosted by the non-RT RIC function 1015 of the SMO 1010.

The Open Fronthaul M-plane interface, between the SMO 1010 and the O-RU 1027, is to support the O-RU management in hybrid mode.

Within the logical architecture of O-RAN, the radio side may include Near-RT RIC 1025, O-CU-CP, O-CU-UP, O-DU, O-eNB, and O-RU functions. The E2 interface may connect E2 Nodes (i.e., O-eNB, O-CU-CP, O-CU-UP and O-DU) to the Near-RT RIC 1025. Although not shown in this figure, the O-eNB does support O-DU and O-RU functions with an Open Fronthaul interface between them.

As stated earlier, the management side may include the SMO 1010 containing a Non-RT-RIC function 1015 with rApps and R1 interface (not shown in the figure). The O-Cloud 1030, on the other hand, may be a cloud computing platform comprising a collection of physical infrastructure nodes that meet O-RAN requirements to host the relevant O-RAN functions (such as Near-RT RIC 1015, O-CU-CP, O-CU-UP and O-DU etc.), the supporting software components (such as Operating System, Virtual Machine Monitor, Container Runtime, etc.) and the appropriate management and orchestration functions.

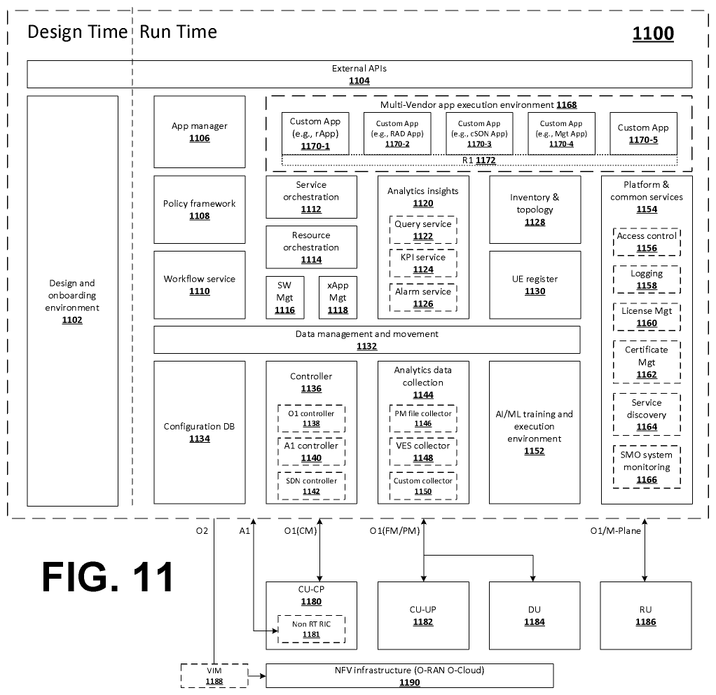

FIG. 11 is a block diagram illustrating an exemplary improved O-RAN architecture in which an NWDAF according to an embodiment of the present disclosure may be operable. As shown in FIG. 11, an improved O-RAN architecture may be a specific implementation of the O-RAN architecture shown in FIG. 10.

As shown in FIG. 11, an SMO 1100, which is similar to that shown in FIG. 10, is indicated by a dashed box. Since the SMO 110 may be a Non-Real Time RIC, the SMO 1100 may be a consolidation of a wide variety of management services and provide many network management like functionalities. Further, the SMO 1100 may provide management services that go well beyond RAN management and may include things such as: Core Management, Transport Management, End to End Slice Management etc. The key capabilities of the SMO 110 that provide RAN support in O-RAN may comprise at least one of:
Non-RT RIC for RAN optimization (A1, O1, O2);
A1 interface could be responsible for AI/ML information exchanging between RT and Non-RT parts, so does data analytics
Fault, Configuration, Accounting, Performance, and Security (FCAPS) interface to O-RAN Network Functions (O1); and
O-Cloud Management, Orchestration and Workflow Management (O2). As shown in FIG. 11, the SMO 1100 including Non-RT RIC capabilities may drive the innovation via open platform to maximize use of O-RAN interfaces (A1, O1, O2), multi-vendor rApps, as well as the AI/ML. In some embodiments, the AI/ML training and execution environment 1152 may be provided in the SMO 1100 to achieve a similar effect as shown in FIG. 6.

In order to support intelligent closed-loop management and control of different time scales, the wireless network intelligent controller (RIC) functional entity is introduced into the overall O-RAN architecture. The core of RIC is to use big data analysis and artificial intelligence technology to perceive and predict the wireless network environment and make decisions about the allocation of wireless resources. According to the processing delay characteristics, RIC may be divided into non-real-time wireless intelligent controllers and near-real-time wireless intelligent controller. The non-real-time wireless network intelligent controller can be embedded in the network management platform to realize the analysis and processing of the entire network-level, multi-dimensional, and ultra-large-scale data volume across domains. It is mainly used to support strategy management and control above the second level. The main functions of the non-real-time intelligent controller may include service and intention strategy management, wireless network analysis, and AI model training. In some embodiments, the trained AI model may be distributed to the near-real-time wireless intelligent controller through the A1 interface for online reasoning and execution. Using the collected massive wireless data, through big data analysis and artificial intelligence algorithms, the non-real-time intelligent controller can effectively extract wireless data characteristics and models, such as network user-level traffic space-time distribution, user mobility characteristics and models, user service types and models, and/or user service experience prediction models. Using these data characteristics and/or AI models, the non-real-time intelligent controller may assist the network management in optimizing the configuration of non-real-time network parameters, such as paging/handover/re-selection parameters. The near-real-time wireless network intelligent controller can be embedded in the CU cloud platform or run independently of the base station to achieve regional network-level, large-scale data analysis, and/or wireless resource management and control. In some embodiments, the control time granularity is about 10 ms to several seconds.

Since other modules are not directly involved in the intelligent paging according to some embodiments of the present disclosure, and the detailed description thereof may be omitted for simplicity.

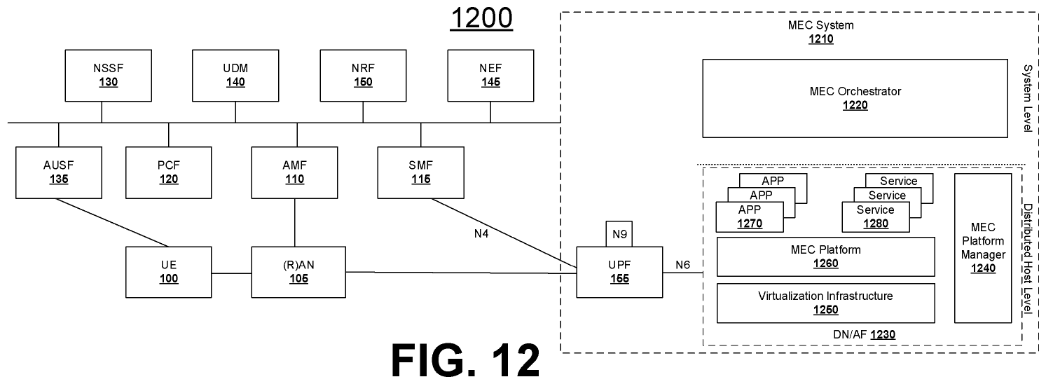

FIG. 12 is a block diagram illustrating an exemplary edging computing architecture 1200 in which an NWDAF according to an embodiment of the present disclosure may be operable. This architecture is similar to that shown in (e) of FIG. 9.

As shown in FIG. 12, the edge computing architecture 1200 may comprise one or more UEs and one or more network functions, for example, those shown in FIG. 1, and therefore a detailed description thereof may be omitted for simplicity. Further, the edge computing architecture 1200 may further comprise an MEC system 1210 (e.g., the MEC system 950 shown in FIG. 9) in which an NWDAF (e.g., the NWDAF 958) may be collocated.

As shown in FIG. 12, one or more UPFs 155, an NWDAF (AI data analytics), and MEC orchestrator 1220 and/or MEC hosts may be collocated on same side of the N6/SGi interface, with same or different Network Functions Virtualization Infrastructures (NFVIs)/cloud native platform. Considering paging system specification on signal flow and control-plane related data collection and data analysis, this embodiment may still propose this kind of collocated NWDAF polymorphic architecture on MEC.

To reduce the OPEX of FFI and increase usability of ML paging, an auto optimization mechanism for updating the AI model may be needed. The preconditions of auto optimization may be:
One Model (cost function), to evaluate the efficiency of ML paging;
One Method, to derive the best confidence level automatically

For the model (or cost function), the core function used in the offline ML tools may be reused for the online model, since the ML tool and its core functions have already been used and verified in FFI by different customers.

For the method, one feasible and gradient descend alike solution may be described in detail below.

In some embodiments, the efficiency of paging profile could be evaluated from at least one of amount of signaling and paging latency, for example, as follows:

$$TotalCost = G ( latency ) ⊗ F ( signal ) \qquad ( 1 )$$

G is a function with a variable of paging latency, G(latency) may be composed of term for the i^{th} paging, G(latency)ᵢ.

F is a function with a variable of amount of paging signals, F(signal) may be composed of term for j^{th} paging F(signal)ⱼ.

In some embodiments, G(latency); may be represented in a form of a power function or an exponential function, for example:

$${G ( latency )}_{i} = λ ( i ) {e}^{{G ( latency )}_{i}^{K}} \qquad ( 2 )$$

where i may indicate the i^{th} paging, λ(i) may be a regularization factor for balancing paging latency and amount of signaling, and K>1 and K∈ [symbol] . For example, the i^{th} element of G(latency) may be calculated as follows:

$${G ( latency )}_{l} = λ ( i ) {e}^{i - 1} \qquad ( 2.1 )$$

$$or$$

$${G ( latency )}_{i} = λ ( i ) {N}^{i - 1} \qquad ( 2.2 )$$

where N>1 and N ∈ [symbol] .

In some embodiments, according to the equation (1), F(signal) may be a function consisting of term for j^{th} paging F(signal)ⱼ:

$${F ( signal )}_{j} = {failurerate ( j - 1 , t , conf )}_{j} * {( P a g i n g S i g n a ls ( j , t , conf ) )}_{j} \qquad ( 3 )$$

$${failurerate ( 0 , t , conf )}_{1} = 1 \qquad ( 4 )$$

where j indicates the j^{th} paging, failurerate (j−1, t, conf); is the paging failure rate for the j−1^{th} paging at a given time t and a given confidence level of conf, PagingSignals(j, t, conf) is the amount of signaling for the j^{th} paging at the given time t and the given confidence level of conf.

In some embodiments, assuming each paging failure rate is independent to others. In some embodiments, the parameter “conf” is only valid when j^{th} paging is ML eNB list paging. In some embodiments, a paging profile may be defined and used in at least one of four levels: eNB, eNB list, TA, TA list. However, the present disclosure is not limited thereto.

In some embodiments, according to the equation (3), tuning paging profile may refer to minimizing the cost function by adjusting the confidence level:

minᵢTotalCost.

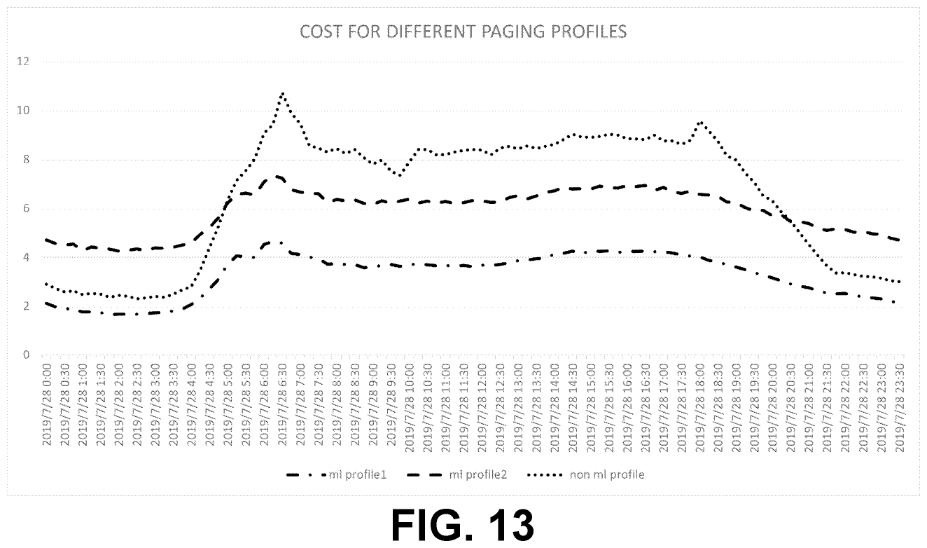

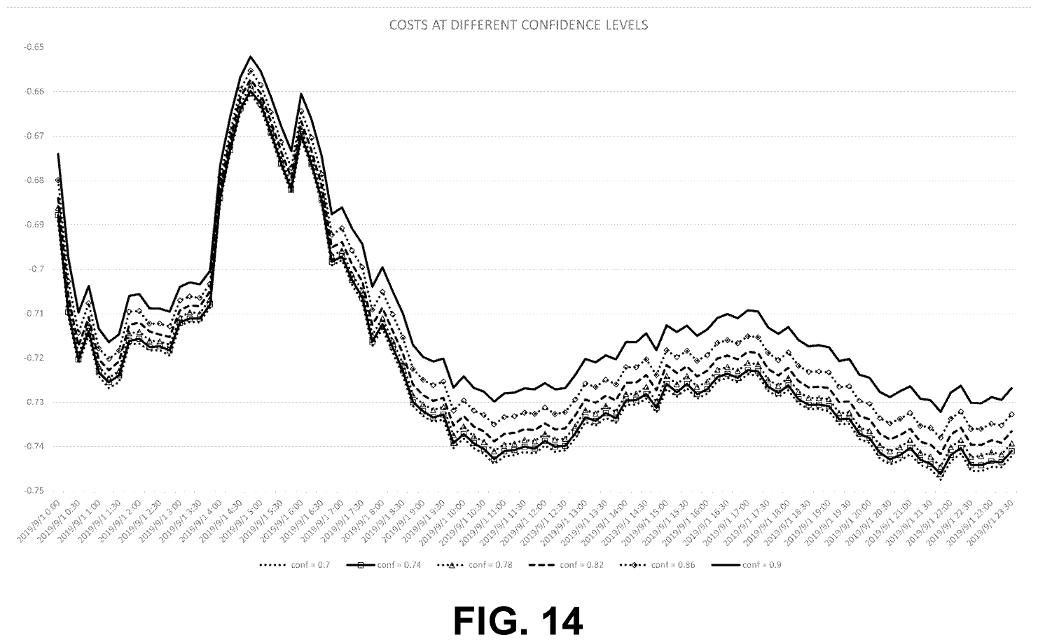

However, directly applying a gradient descending method on the cost function does not work since the cost function is also impacted by both time and paging profiles. For example, in a weekday, it is obvious that signaling and latency increase in rush hour due to mobility while signaling and latency decrease in nighttime. For example, FIG. 13 and FIG. 14 show field results from trial. As can be seen from FIG. 13 and FIG. 14, the cost function may vary over time and different confidence levels (e.g., ml profile 1, ml profile 2, and non ml profile shown in FIG. 13, conf=0.7, 0.74, . . . shown in FIG. 14). Further, the time factor may be isolated and the best cost function value (i.e., the extremum value) related to confidence shall be found.

According to the equation (3), since the paging failure rate is a function of confidence level, while on the other hand, the confidence level of paging would have an extremum value based on the statistics, including:
Paging signals;
Confidence.

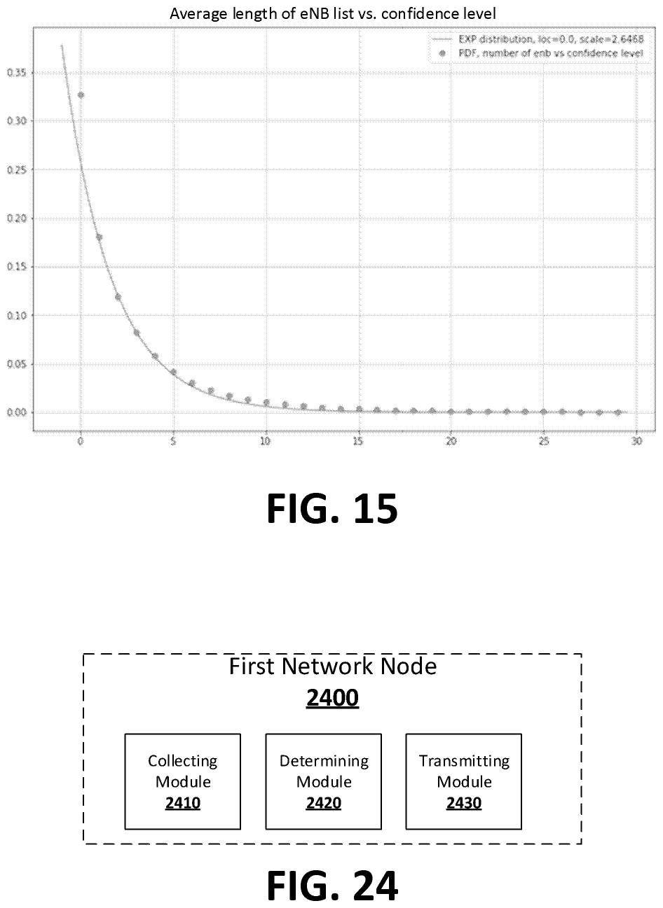

Since PDF(N_{Paging signals, eNB}) is a monotonically decreasing function, i.e. PDF′^{(N}^{_{enblist}}⁾<0 then Signal″(N_{enblist})>0. The original cost function must be a convex function as shown in FIG. 15.

With Machine learning (e.g., real AI, automation tuning, including self-learning, such as XGBoost, Gradient Descent for convergence time, validation), the cost function may be known. The confidence level may be updated at each learning interval. If the minimal cost exists, sooner or later the best confidence level and paging profile setup may be achieved.

From the equation (1), it is known that the cost function of paging is positively related to the confidence level, which is critical for confidence self-learning with AL/ML. With time-step self-learning on “confidence-cost” function, the step forward learning may have achieved the target that balances the best time-step confidence and time-based cost function.

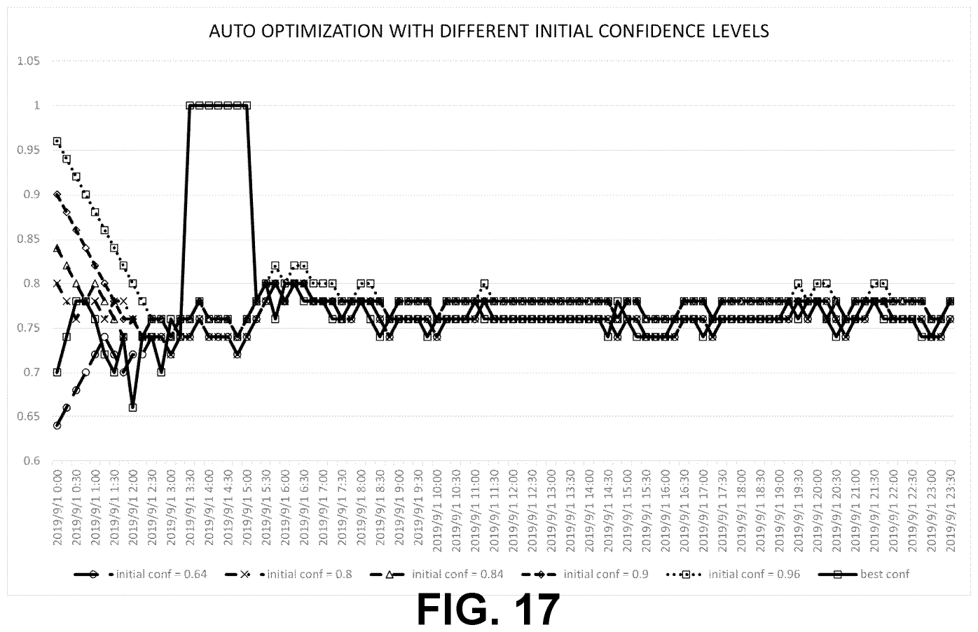

FIG. 16 is a diagram illustrating an exemplary auto-tuning scheme for intelligent paging according to an embodiment of the present disclosure. As indicated by the successive darker arrows, the auto-tuning algorithm may finally succeed in finding the convergence point including the factors: time, cost function, and/or time-step confidence. Some field trial information in commercial network may be hidden as shown in FIG. 17.

For example, a current confidence level (e.g., the confidence level of 0.82 at time “08:00:00 2019 Sep. 1”) may be determined at least partially based on a previous confidence level (e.g., the confidence level of 0.86 at time “07:45:00 2019 Sep. 1”), one or more candidate confidence levels that are different from the previous confidence level (e.g., the confidence levels of 0.9 and 0.82 at time “07:45:00 2019 Sep. 1”), a previous cost associated with the previous confidence level for the previous training interval, and one or more estimated costs associated with the one or more candidate confidence levels for the previous training interval. After that, the ML model may be trained based on the cost function at the current confidence level (e.g., the confidence level of 0.82 at time “08:00:00 2019 Sep. 1”) and the estimated cost at the one or more candidate confidence levels. In some embodiments, the previous cost (e.g., the cost at the confidence level of 0.86 and at time “07:45:00 2019 Sep. 1”) may be compared with the one or more estimated costs (e.g., the costs at the confidence levels of 0.9 and 0.82 and at time “07:45:00 2019 Sep. 1”). After that, the current confidence level may be determined as one of the previous confidence level and the one or more candidate confidence levels that has the lowest cost (e.g., the confidence level of 0.82).

For another example, a current confidence level (e.g., the confidence level of 0.7 at time “08:45:00 2019 Sep. 1”) may be determined at least partially based on a previous confidence level (e.g., the confidence level of 0.74 at time “08:30:00 2019 Sep. 1”), one or more candidate confidence levels that are different from the previous confidence level (e.g., the confidence level of 0.7 at time “08:30:00 2019 Sep. 1”), a previous cost associated with the previous confidence level for the previous training interval, and one or more estimated costs associated with the one or more candidate confidence levels for the previous training interval. After that, the ML model may be trained based on the cost function at the current confidence level (e.g., the confidence level of 0.7 at time “08:45:00 2019 Sep. 1”) and the estimated cost at the one or more candidate confidence levels. In some embodiments, the previous cost (e.g., the cost at the confidence level of 0.74 and at time “08:30:00 2019 Sep. 1”) may be compared with the one or more estimated costs (e.g., the costs at the confidence levels of 0.7 and at time “08:30:00 2019 Sep. 1”). After that, the current confidence level may be determined as one of the previous confidence level and the one or more candidate confidence levels that has the lowest cost (e.g., the confidence level of 0.7).

However, the present disclosure is not limited thereto. In some other embodiments, other number of candidates (e.g., 3 or more) may be selected to be compared with the previous cost for determining the current confidence level.

During the above extremum value solution of the equation (3), the complexity reduction may be required for the PCC implementation. Therefore, the convergence of the cost function and the confidence level may be achieved by a partial differential solving method.

In some embodiments, assuming that each i^{th} confidence level and cost function extremum value may be determined by an independent extremum value solving procedure:

$${F}^{′} ( conf ) = {\sum }_{i = 1}^{N} \frac{\partial {F}_{i} ( f a i l urerate ( i - 1 , t , c o n {f}_{i} )}{\partial c o n {f}_{i}} \qquad ( 5 )$$

where i>0, and

$$\frac{\partial {F}_{i} ( failurerate ( i - 1 , t , {conf}_{i} )}{\partial c o n {f}_{i}}$$

indicates a partial derivative of Fᵢ(failurerate (i−1, t, confᵢ) with respect to the variable confᵢ. In some embodiments, an extremum value of F(signal) may be determined by solving a partial differential equation as follows:

$${F}^{′} ( conf ) = \frac{\partial {F}_{j} ( f a i l u r e r a te ( j - 1 , t , c o n {f}_{j} )}{\partial c o n {f}_{j}} {F}_{i} ( failurerate ( i - 1 , t , {conf}_{i} ) ) + \frac{\partial {F}_{i} ( f a i l u r e r a t e ( i - 1 , t , c o n {f}_{i} )}{\partial c o n {f}_{i}} {F}_{j} ( failurerate ( j - 1 , t , {conf}_{j} ) ) + … \qquad ( 6 )$$

where i≠j≠0, i, j>0, and

$$\frac{\partial {F}_{i} ( failurerate ( i - 1 , t , {conf}_{i} )}{\partial c o n {f}_{i}}$$

indicates a partial derivative of Fᵢ(failurerate (i−1, t, confᵢ) with respect to the variable confi-Therefore, by a partial differential solving method on the cost function, some embodiments of the present disclosure may propose an independent partial differential solving of i^{th} confiand j^{th} conf; procedure, wherein the partial differential order is i^{th} or j^{th} and so on.

Please note that the order of partial differential of the equations (5) and (6) has no impact on the final extremum value solution of the equation (3). Further, a monotonic approach method may be proposed to achieve a faster convergence of the confidence level. Thanks to the symmetry feature of results and monotonic solving procedure, the computation complexity may be reduced by 50%, and the convergence ratio may be improved by 50%.

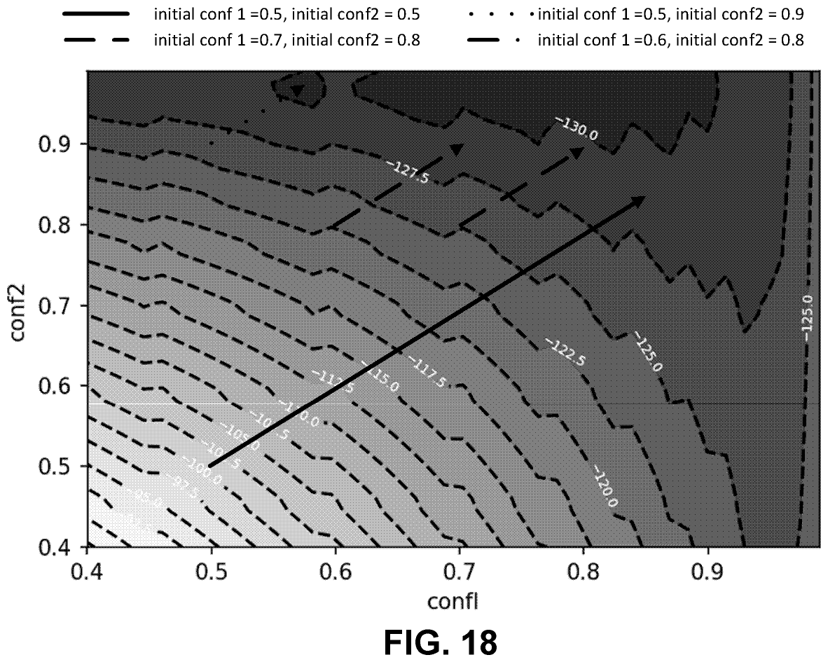

FIG. 18 is a diagram illustrating an exemplary auto-tuning scheme for intelligent paging with a reduced complexity according to an embodiment of the present disclosure. As clearly shown in FIG. 18, the solutions that are found by the above method may approach the extremum value (e.g., the lowest cost −130.0) no matter what the initial confidence levels are.

As mentioned earlier, an offline ML tool is developed to facilitate the FFI and optimize the performance of ML paging. FIG. 19 is a block diagram illustrating exemplary intelligent paging in an offline mode according to an embodiment of the present disclosure. Briefly, the ML tool may read and parse EBM data, generate both offline paging model and one simulated traffic model. After that, the tool may try optimizing the paging model by tuning the hyper-parameters used by the ML paging. The final output of the tool is the optimal configuration for PCC/VNF that handles network traffic.

Please note that the embodiment shown in FIG. 19 is a specific implementation of the offline ML tools 630 shown in FIG. 6, and therefore detailed description thereof may be omitted for simplicity.

The main reason why the ML tool is developed is that the default configuration for ML paging is normally not the best value in a live network. In some worst case, the default configuration might not even have any paging signal reduction in the live network. The tools could help customer to find the best ML paging configuration. However, the cost (i.e., OPEX) is rather high as mentioned earlier.

For example, two additional servers are needed by the ML tools as clearly shown in FIG. 19, one for collecting EBM data (e.g., the stream server 1930) and another for processing the EBM data (e.g., the AI server 1910). If a network operator does not have a capability or does not want to deploy the AI server 1910, an alternative for the network operator is to at least provide one stream server to store the EBM data, anonymize the EBM data, and provide anonymized data to a third party which hosts the AI server 1910. The AI server 1910 may process the anonymized EBM data and provide feedback to the network operator (e.g., the PCC/VNF 1920). As the volume of EBM data per day is counted in TBs, the storage cost of the EBM data could be millions U.S. dollars for the network operator per year, not to mention the cost of deploying one optional AI server.

Further, as the ML tools handle offline data and the huge offline EBM data requires several weeks to process, a typical cycle for collecting the data, processing the data, and providing feedback may require one to two months. The traffic model and radio network topology could be changing rapidly during this cycle. The potential risk of current ML tool is the optimal value that is learned from old data may not work for the latest traffic model. The long feedback loop also involves collaboration between network operators, supporters, and third party engineers.

On the other hand, with the online model (e.g., those shown in FIG. 6 and FIG. 9), no EBM data needs to be anonymized and preprocessed, as mentioned earlier. In other words, the processing of the EBM data may be skipped. A VNF/PCC may directly report UE mobility information to a collocated NWDAF for updating the online model. Therefore, the extra stream server 1930 and the AI server 1910 may be omitted. Further, with the online model, paging statistics may also be directly reported to the collocated NWDAF. In such a case, the online tools may evaluate the performance of current paging profile and optimize paging model and VNF configuration in real time, and therefore may provide a quick response to changes of the traffic model. Furthermore, with the online model, there is no need for human interference. In other words, the optimization may be done automatically and could be self-adapted to different traffic models and network topologies. In general, with the online ML tool (or the collocated NWDAF), the OPEX may be expected to be significantly reduced in both deploying and optimizing ML paging in live network.

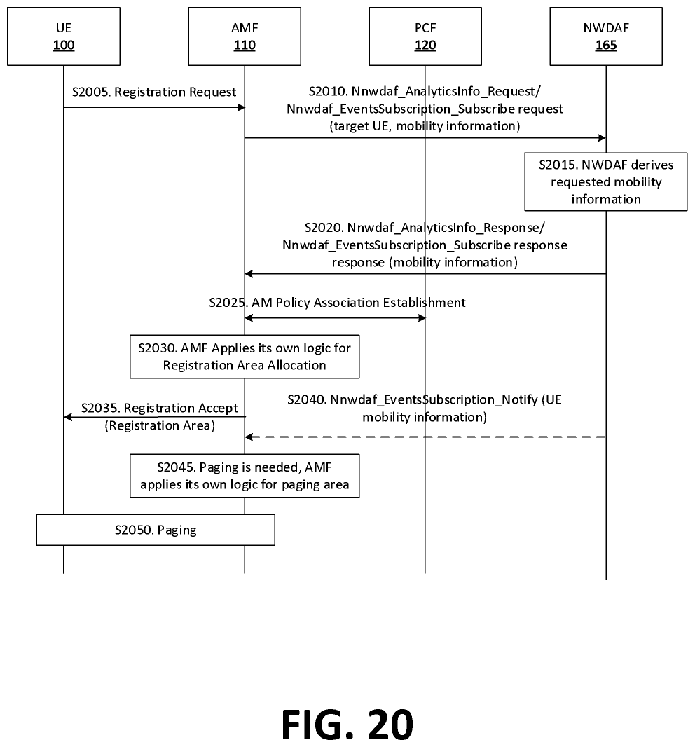

Further, no matter whether the NWDAF is collocated with other NFs/AFs/OAMs, following procedure may be used for achieving the intelligent paging as well. FIG. 20 is a diagram illustrating an exemplary procedure for AMF using NWDAF outputs to optimize UE mobility according to an embodiment of the present disclosure.

As shown in FIG. 20, an AMF 110 may use UE mobility information as provided by an NWDAF 165. The UE mobility information as provided by the NWDAF 165 may contain historical UE mobility information, predicted UE mobility information, or both, and can be used by the AMF 110 as an input for optimizing UE mobility, e.g. registration area determination, paging area determination, etc.

At step S2005, a UE 100 may initiate its registration by transmitting a Registration Request to the AMF 110.

At step S2010, the AMF 110 may, based on local policies, request the NWDAF 165 for mobility information for the UE 100, using either Nnwdaf_AnalyticsInfo or Nnwdaf_EventsSubscription service. The AMF 110 can request for statistics, for predictions, or for both.

At step S2015, the NWDAF 165 may derive requested mobility information for the UE 100. Please note that the NWDAF 165 can derive UE mobility information based on data collected for the UE 100, e.g. using framework procedure that will be agreed to be progressed as part of normative work for eNA data collection.

At step S2020, the NWDAF 165 may provide requested UE mobility information to the AMF 110.

At step S2025, during AM Policy Association Establishment, the PCF 120 may provide the AMF 110 with the Access and mobility related policy control information (e.g. service area restrictions).

At step S2030, the AMF 110 may derive registration area for the UE 100 based on the UE mobility information provided by the NWDAF 165 and/or the service area restrictions as instructed by the PCF 120. Please note that the AMF logic for deriving registration area may be similar to those described above with reference to FIG. 6 and/or FIG. 16.

At step S2035, the AMF 110 may send a Registration Accept message to the UE 100 containing the allocated Registration Area to the UE 110.

At step S2040, if the AMF 110 used Nnwdaf_EventsSubscription service in step S2010, the AMF 110 may receive updated mobility information from the NWDAF 165 for that UE 100.

At step S2045, when the AMF 110 detects that paging the UE 100 is needed, the AMF 110 may use the information as provided by the NWDAF 165 to determine the paging area. Please note that the AMF logic for deriving paging area may be similar to those described above with reference to FIG. 6 and/or FIG. 16. Please also note that this step could be reused as collocated NWDAF paging architecture described above.

At step S2050, the AMF 110 may page the UE 100 in the area determined.

In some embodiments, the PCF 120, the NWDAF 165, and the AMF 110 may be considered as collocated within a same entity. In some embodiments, the collocated NWDAF may be a continuous evolution form of standalone NWDAF for different feasible product solutions.

FIG. 21 is a flow chart of an exemplary method 2100 at a first network node for facilitating a second network node in paging a UE according to an embodiment of the present disclosure. The method 2100 may be performed at an NWDAF (e.g., any of the NWDAFs 165, 620, 820, 916, 928, 932, 946, 970, 1910, 2300). The method 2100 may comprise step S2110, S2120, and S2130. However, the present disclosure is not limited thereto. In some other embodiments, the method 2100 may comprise more steps, less steps, different steps, or any combination thereof. Further the steps of the method 2100 may be performed in a different order than that described herein. Further, in some embodiments, a step in the method 2100 may be split into multiple sub-steps and performed by different entities, and/or multiple steps in the method 2100 may be combined into a single step.

The method 2100 may begin at step S2110 where paging information for the UE may be collected from one or more network nodes.

At step S2120, an ML model may be determined at least partially based on the paging information.

At step S2130, the determined ML model and/or a configuration that is derived from the ML model may be transmitted to the second network node for use by the second network node in paging the UE.

In some embodiments, the first network node may be an NWDAF that is collocated with at least one of: an MME, an AMF, a CN node, a RAN node, a PCC, a PCG, an OSS, a CCES, a MEC node, and an O-RAN node. In some embodiments, the NWDAF may be deployed as a service in a standalone ADP at a PCC, and the second network node may be the MME or the AMF. In some embodiments, the step S2110 may comprise that paging information for the UE may be received from a collocated mobility management module. In some embodiments, the paging information may comprise at least one of: location information in terms of TA, eNB/gNB, or cell, time information, and UE service type.

In some embodiments, the method 2100 may further comprise that optimization proposal information for optimizing a paging profile for the UE may be transmitted to a network management system. In some embodiments, the NWDAF may be deployed as a custom application in an SMO framework at an O-RAN node, and the second network node may be a Non-RT RIC. In some embodiments, the A1 interface of the O-RAN node may be used for exchanging AI/ML information and/or information for data analytics. In some embodiments, the ML model may be trained at the Non-Real Time RIC of the O-RAN node, and the trained ML model may be passed from the Non-Real Time RIC to the

Near-Real Time RIC via the A1 interface. In some embodiments, the ML model may be trained for extracting at least one of: network user-level traffic space-time distribution, user mobility characteristics and/or models, user service types and/or models, and user experience prediction models.

In some embodiments, the first network node may be an AI server that is located separately from the second network node. In some embodiments, the collected information may be anonymized. In some embodiments, the paging information may comprise at least one of: mobility information for one or more UEs comprising the UE, statistical paging information for the one or more UEs, core network information for a core network to which the first network node belongs, and supplemental information. In some embodiments, the statistical paging information may comprise at least one of: a paging success ratio in each paging phase, a number of paging messages in each paging phase, and paging attempts in each paging phase. In some embodiments, the core network information may comprise relationship between each TA and eNB/gNB. In some embodiments, the supplemental information may comprise information that facilitates the MME or AMF in linking the ML model to an OAM configuration.

In some embodiments, the step of determining the ML model for the UE may comprise that mobility information for the UE may be analyzed. The step of determining the ML model for the UE may further comprise that statistical paging information may be evaluated to simulate paging at one or more confidence levels. The step of determining the ML model for the UE may further comprise that the ML model for the UE may be determined at least partially based on the analyzed mobility information and/or the evaluated statistical paging information. In some embodiments, an initial configuration of the ML model may be configured by an OAM module. In some embodiments, the method 2100 may further comprise that the OAM module may be provided with at least one of history of confidence levels, performance of the current paging procedure, and suggestion for paging profiles.

In some embodiments, the step of determining the ML model for the UE at least partially based on the paging information may comprise that the ML model may be trained based on a cost function that may be determined at least partially based on an amount of signaling for successfully paging the UE and/or a paging latency. In some embodiments, the cost function may be calculated as follows:

$$TotalCost = G ( latency ) ⊗ F ( signal )$$

where TotalCost may be the cost to be calculated, G(latency) may be a function with an input argument of latency, F(signal) may be a function with an input argument of amount of signaling, and “⊗” may be an operator for calculating an inner product of its operands.

In some embodiments, the i^{th} element of G(latency) may be calculated as follows:

$${G ( latency )}_{i} = λ ( i ) {e}^{{G ( latency )}_{i}^{K}}$$

where i may indicate the it paging, λ(i) may be a regularization factor for balancing paging latency and amount of signaling, and K>1 and K∈ [symbol] .

In some embodiments, the i^{th} element of G(latency) may be calculated as follows:

$${G ( latency )}_{i} = λ ( i ) {e}^{i - 1}$$

$$or$$

$${G ( latency )}_{i} = λ ( i ) {N}^{i - 1}$$

where N>1 and N∈ [symbol] .

In some embodiments, the j^{th} element of F(signal) may be calculated as follows:

$${F ( signal )}_{j} = {failurerate ( j - 1 , t , conf )}_{j} * {( PagingSignals ( j , t , conf ) )}_{j}$$

$${failurerate ( 0 , t , conf )}_{1} = 1$$

where j may indicate the j^{th} paging, failurerate (j−1, t, conf); may be the paging failure rate for the j−1^{th} paging at a given time t and a given confidence level of conf, PagingSignals(j, t, conf) may be the amount of signaling for the j^{th} paging at the given time t and the given confidence level of conf.

In some embodiments, the step of training the ML model based on the cost function may comprise that a current confidence level may be determined at least partially based on a previous confidence level, one or more candidate confidence levels that may be different from the previous confidence level, a previous cost associated with the previous confidence level for the previous training interval, and one or more estimated costs associated with the one or more candidate confidence levels for the previous training interval. The step of training the ML model based on the cost function may comprise that the ML model may be trained based on the cost function at the current confidence level and the estimated cost at the one or more candidate confidence levels.

In some embodiments, the step of determining the current confidence level may comprise that the previous cost may be compared with the one or more estimated costs. The step of determining the current confidence level may comprise that the current confidence level may be determined as one of the previous confidence level and the one or more candidate confidence levels that may have the lowest cost.

In some embodiments, an extremum value of F(signal) may be determined by solving a partial differential equation as follows:

$${F}^{′} ( conf ) = {\sum }_{i = 1}^{N} \frac{\partial {F}_{i} ( f a i l u r e r a t e ( i - 1 , t , c o n {f}_{i} )}{\partial c o n {f}_{i}}$$

where i>0, and

$$\frac{\partial {F}_{i} ( failurerate ( i - 1 , t , {conf}_{i} )}{\partial c o n {f}_{i}}$$

may indicate a partial derivative of Fᵢ(failurerate (i−1, t, confᵢ) with respect to the variable confᵢ.

In some embodiments, an extremum value of F(signal) may be determined by solving a partial differential equation as follows:

$${F}^{′} ( conf ) = \frac{\partial {F}_{j} ( f a i l u r e r a te ( j - 1 , t , c o n {f}_{j} )}{\partial c o n {f}_{j}} {F}_{i} ( failurerate ( i - 1 , t , con {f}_{i} ) ) + \frac{\partial {F}_{i} ( failurerate ( i - 1 , t , c o n {f}_{i} )}{\partial c o n {f}_{i}} {F}_{j} ( failurerate ( j - 1 , t , con {f}_{j} ) ) + …$$

where i≠j≠0, i, j>0, and

$$\frac{\partial {F}_{i} ( failurerate ( i - 1 , t , c o n {f}_{i} )}{\partial c o n {f}_{i}}$$

may indicate a partial derivative of _{F}(failurerate(i−1, t, confᵢ) with respect to the variable confᵢ.

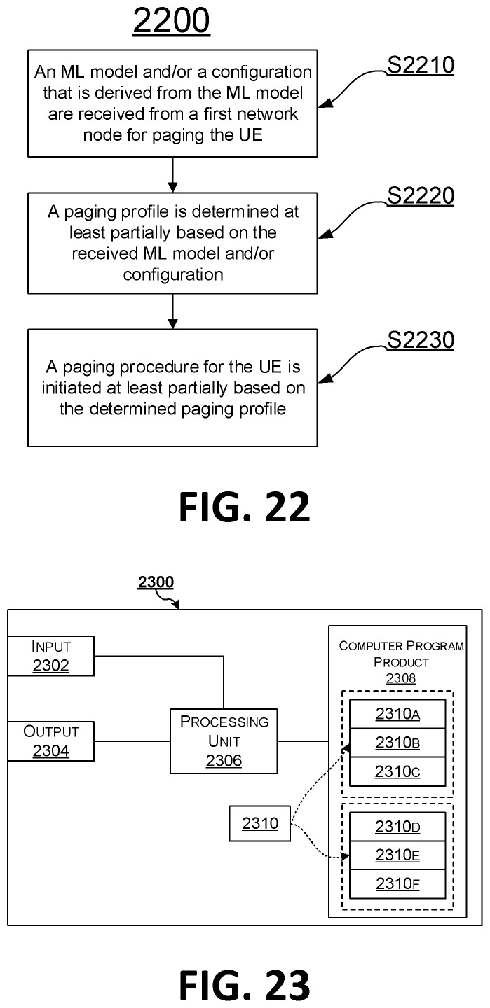

FIG. 22 is a flow chart of an exemplary method 2200 at a second network node for paging a UE according to an embodiment of the present disclosure. The method 2200 may be performed at an AMF/MME (e.g., the AMF 110). The method 2200 may comprise step S2210, S2220, and S2230. However, the present disclosure is not limited thereto. In some other embodiments, the method 2200 may comprise more steps, less steps, different steps, or any combination thereof. Further the steps of the method 2200 may be performed in a different order than that described herein. Further, in some embodiments, a step in the method 2200 may be split into multiple sub-steps and performed by different entities, and/or multiple steps in the method 2200 may be combined into a single step.

The method 2200 may begin at step S2210 where an ML model and/or a configuration that may be derived from the ML model may be received from a first network node for paging the UE.

At step S2220, a paging profile may be determined at least partially based on the received ML model and/or configuration.

At step S2230, a paging procedure for the UE may be initiated at least partially based on the determined paging profile.

In some embodiments, the first network node may be an NWDAF that is collocated with the second network node, and the second network node may be at least one of: an MME; an AMF, a CN node, a RAN node, a PCC, a PCG, an OSS, a CCES, a MEC node, and an O-RAN node. In some embodiments, the second network node may be deployed as a mobility management module at a PCC. In some embodiments, the method 2200 may further comprise that paging information for the UE may be transmitted to the collocated NWDAF. In some embodiments, the paging information may comprise at least one of: location information in terms of TA, eNB/gNB, or cell, time information, and UE type.

In some embodiments, the method 2200 may further comprise that a paging profile for updating the paging profile stored at the second network node may be received from a network management system. In some embodiments, the NWDAF may be deployed as a custom application in an SMO framework at an O-RAN node, and the second network node may be a Near-Real Time RIC. In some embodiments, the A1 interface of the O-RAN node may be used for exchanging AI/ML information and/or information for data analytics. In some embodiments, the ML model may be trained at the Non-Real Time RIC of the O-RAN node, and the trained ML model may be passed from the Non-Real Time RIC to the Near-Real Time RIC via the A1 interface. In some embodiments, the ML model may be trained for extracting at least one of: network user-level traffic space-time distribution, user mobility characteristics and/or models, user service types and/or models, and user experience prediction models. In some embodiments, the NWDAF may be deployed as an application or service on a MEC platform at a MEC host or collocated with a MEC orchestrator, and the second network node may be a UPF. In some embodiments, the first network node may be an AI server that is located separately from the second network node.

FIG. 23 schematically shows an embodiment of an arrangement which may be used in a first network node (e.g., NWDAF) or a second network node (e.g., AMF/MME) according to an embodiment of the present disclosure. Comprised in the arrangement 2300 are a processing unit 2306, e.g., with a Digital Signal Processor (DSP) or a Central Processing Unit (CPU). The processing unit 2306 may be a single unit or a plurality of units to perform different actions of procedures described herein. The arrangement 2300 may also comprise an input unit 2302 for receiving signals from other entities, and an output unit 2304 for providing signal(s) to other entities. The input unit 2302 and the output unit 2304 may be arranged as an integrated entity or as separate entities.

Furthermore, the arrangement 2300 may comprise at least one computer program product 2308 in the form of a non-volatile or volatile memory, e.g., an Electrically Erasable Programmable Read-Only Memory (EEPROM), a flash memory and/or a hard drive. The computer program product 2308 comprises a computer program 2310, which comprises code/computer readable instructions, which when executed by the processing unit 2306 in the arrangement 2300 causes the arrangement 2300 and/or the first network node and/or the second network node in which it is comprised to perform the actions, e.g., of the procedure described earlier in conjunction with FIG. 2, FIG. 3, FIG. 6, FIG. 8, and FIG. 13 to FIG. 22 or any other variant.

The computer program 2310 may be configured as a computer program code structured in computer program modules 2310A-2310C. Hence, in an exemplifying embodiment when the arrangement 2300 is used in a first network node, the code in the computer program of the arrangement 2300 includes: a module 2310A for collecting paging information for the UE from one or more network nodes; a module 2310B for determining a machine learning model at least partially based on the paging information; and a module 2310C for transmitting, to the second network node, the determined ML model and/or a configuration that is derived from the ML model for use by the second network node in paging the UE.

The computer program 2310 may be further configured as a computer program code structured in computer program modules 2310D-2310F. Hence, in an exemplifying embodiment when the arrangement 2300 is used in a second network node, the code in the computer program of the arrangement 2300 includes: a module 2310D for receiving, from a first network node, an ML model and/or a configuration that is derived from the ML model, for paging the UE; a module 2310E for determining a paging profile at least partially based on the received ML model and/or configuration; and a module 2310F for initiating a paging procedure for the UE at least partially based on the determined paging profile.

The computer program modules could essentially perform the actions of the flow illustrated in FIG. 2, FIG. 3, FIG. 6, FIG. 8, and FIG. 13 to FIG. 22, to emulate the first network node and/or the second network node. In other words, when the different computer program modules are executed in the processing unit 2306, they may correspond to different modules in the first network node and/or the second network node.

Although the code means in the embodiments disclosed above in conjunction with FIG. 23 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor.

The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

Correspondingly to the method 2100 as described above, an exemplary first network node is provided. FIG. 24 is a block diagram of a first network node 2400 according to an embodiment of the present disclosure. The first network node 2400 may be, e.g., the NWDAF 165 in some embodiments.

The first network node 2400 may be configured to perform the method 2100 as described above in connection with FIG. 21. As shown in FIG. 24, the first network node 2400 may comprise a collecting module 2410 for collecting, from one or more network nodes, paging information for the UE; a determining module 2420 for determining an ML model at least partially based on the paging information; and a transmitting module 2430 for transmitting, to the second network node, the determined ML model and/or a configuration that is derived from the ML model for use by the second network node in paging the UE.

The above modules 2410, 2420, and/or 2430 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 21. Further, the first network node 2400 may comprise one or more further modules, each of which may perform any of the steps of the method 2100 described with reference to FIG. 21.

Correspondingly to the method 2200 as described above, an exemplary second network node is provided. FIG. 25 is a block diagram of a second network node 2500 according to an embodiment of the present disclosure. The second network node 2500 may be, e.g., the AMF 110 in some embodiments.

The second network node 2500 may be configured to perform the method 2200 as described above in connection with FIG. 22. As shown in FIG. 25, the second network node 2500 may comprise a receiving module 2510 for receiving, from a first network node, an ML model and/or a configuration that is derived from the ML model, for paging the UE; a determining module 2520 for determining a paging profile at least partially based on the received ML model and/or configuration; and an initiating module 2530 for initiating a paging procedure for the UE at least partially based on the determined paging profile.

The above modules 2510, 2520, and/or 2530 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 22. Further, the second network node 2500 may comprise one or more further modules, each of which may perform any of the steps of the method 2200 described with reference to FIG. 22. The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method at a first network node for facilitating a second network node in paging a user equipment, the method comprising:
collecting, from one or more network nodes, paging information for the UE ;
determining a machine learning (ML) model at least partially based on the paging information; and
transmitting, to the second network node, the determined ML model and/or a configuration that is derived from the ML model for use by the second network node in paging the UE.

2. The method of claim 1, wherein:
the first network node is a Network Data Analytics Function (NWDAF) that is collocated with at least one of:
a Mobility Management Entity (MME);
an Access and Mobility Function (AMF);
a Core Network (CN) node;
a Radio Access Network (RAN) node;
a Packet Core Controller (PCC);
a Packet Core Gateway (PCG);
an Operation Supporting System (OSS);
a Multi-access Edge Computing (MEC) node; and
an O-RAN node; and
the NWDAF is deployed in a standalone Application Development Platform (ADP) at a PCC, and the second network node is the MME or the AMF.

3. (canceled)

4. The method of claim 1, wherein the step of collecting, from one or more network nodes, paging information for the UE comprises:
receiving, from a collocated mobility management module, paging information for the UE;
wherein the c aging information comprises at least one of:
location information in terms of tracking area (TA), eNB/gNB, or cell:
time information; and
UE service tv e

5. (canceled)

6. (canceled)

7. The method of claim 2, wherein:
the NWDAF is deployed as a custom application in a Service Management & Orchestration (SMO) framework at an O-RAN node, and the second network node is a Non-Real Time RAN Intelligent Controller (Non-RT RIC);
an A1 interface of je O-RAN node is used for exchanging Artificial Intelligence (AD)/ML information and/or information for data analytics; and
the ML model is trained at the Non-Real Time RIC of the O-RAN node, and the trained ML model is passed from the Non-Real Time RIC to the Near-Real Time RIC via the A1 interface

8. (canceled)

9. (canceled)

10. The method of claim-9 claim Z, wherein the ML model is trained for extracting at least one of:
network user-level traffic space-time distribution;
user mobility characteristics and/or models;
user service types and/or models; and
user experience prediction models.

11. The method of claim 1, wherein the first network node is an AI server that is located separately from the second network node, and wherein the paging information that has been collected is anonymized.

12. (canceled)

13. The method of any of claim 1, wherein the paging information comprises at least one of:
mobility information for one or more UEs comprising the UE;
statistical paging information for the one or more UEs, wherein the statistical paging information comprises at least one of a paging success ratio in each paging phase, a number of paging messages in each paging phase, and paging attempts in each paging phase;
core network information indicating relationship between each tracking area (TA) and eNB/qNB for a core network to which the first network node belongs; and
supplemental information that facilitates a Mobility Management Entity (MME) or an Access and Mobility Function (AMF) in linking the ML model to an Operation and Maintenance (OAM) configuration.

14. (canceled)

15. (canceled)

16. (canceled)

17. The method of claim 1, wherein the step of determiningthe ML model for the UE comprises:
analyzing mobility information for the UE;
evaluating statistical paging information to simulate paging at one or more confidence levels; and
determining the ML model for the UE at least partially based on the analyzed mobility information and/or the evaluated statistical paging information.

18. The method of claim 17, wherein an initial configuration of the ML model is configured by an OAM module, and wherein the method further comprises:
providing the OAM module with at least one of history of confidence levels, performance of the current paging, procedure, and suggestion for paging profiles.

19. (canceled)

20. The method of claim 1, wherein the step of determining the ML model for the UE at least partially based on the paging information comprises:
training the ML model based on a cost function that is determined at least partially based on an amount of signaling for successfully paging the UE and/or a paging latency.

21. The method of claim 20, wherein the cost function is calculated as follows:
$$TotalCost = G ( latency ) ⊗ F ( signal )$$
where TotalCost is the cost to be calculated, G(latency) is a function with an input argument of latency, F(signal) is a function with an input argument of amount of signaling, and “⊗” is an operator for calculating an inner product of its operands.

22. The method of claim 21, wherein the i^{th} element of G(latency) is calculated as follows:
$${G ( latency )}_{i} = λ ( i ) {e}^{{G ( latency )}_{i}^{K}}$$
where i indicates the i^{th} paging, λ(t) is a regularization factor for balancing paging latency and amount of signaling, and K>1 and K∈ [symbol] .

23. The method of claim 22, wherein the i^{th} element of G(latency) is calculated as follows:
$${G ( latency )}_{i} = λ ( i ) {e}^{i - 1}$$
$$or$$
$${G ( latency )}_{i} = λ ( i ) {N}^{i - 1}$$
where N>1 and N∈ [symbol] .

24. The method of claim 21, the j^{th} element of F(signal) is calculated as follows:
$${F ( signal )}_{j} = {failurerate ( j - 1 , t , conf )}_{j} * {( PagingSignals ( j , t , conf ) )}_{j}$$
$${failurerate ( 0 , t , conf )}_{1} = 1$$
where j indicates the j^{th} paging, failurerate(j−1, t, conf)ⱼ is the paging failure rate for the j−1^{th} paging at a given time t and a given confidence level of conf, PagingSignals(j, t, conf) is the amount of signaling for the j^{th} paging at the given time t and the given confidence level of conf.

25. The method of claim 24, wherein the step of training the ML model based on the cost function comprises:
determining a current confidence level at least partially based on a previous confidence level, one or more candidate confidence levels that are different from the previous confidence level, a previous cost associated with the previous confidence level for the previous training interval, and one or more estimated costs associated with the one or more candidate confidence levels for the previous training interval; and
training the ML model based on the cost function at the current confidence level and the estimated cost at the one or more candidate confidence levels.

26. The method of claim 25, wherein the step of determining the current confidence level comprises:
comparing the previous cost with the one or more estimated costs; and
determining the current confidence level as one of the previous confidence level and the one or more candidate confidence levels that has the lowest cost.

27. The method of claim 24, wherein an extremum value of F(signal) is determined by solving a partial differential equation as follows:
$${F}^{′} = ( conf ) = {\sum }_{i = 1}^{N} \frac{\partial {F}_{i} ( failurerate ( i - 1 , t , {conf}_{i} )}{\partial {conf}_{i}}$$
where i>0, and
$$\frac{\partial {F}_{i} ( failurerate ( i - 1 , t , {conf}_{i} )}{\partial {conf}_{i}}$$
indicates a partial derivative of Fᵢ(failurerate (i−1, t, confₜ) with respect to the variable confr.

28. The method (2100) of any of claims-26.claim 24, wherein an extremum value of F(signal) is determined by solving a partial differential equation as follows:
$${F}^{′} ( conf ) = \frac{\partial {F}_{j} ( f a i l u r e r a te ( j - 1 , t , c o n {f}_{j} )}{\partial c o n {f}_{j}} {F}_{i} ( failurerate ( i - 1 , t , con {f}_{i} ) ) + \frac{\partial {F}_{i} ( failurerate ( i - 1 , t , c o n {f}_{i} )}{\partial c o n {f}_{i}} {F}_{j} ( failurerate ( j - 1 , t , con {f}_{j} ) ) + …$$
where i≠j≠0, t, j>0, and
$$\frac{\partial {F}_{i} ( failurerate ( i - 1 , t , c o n {f}_{i} )}{\partial c o n {f}_{i}}$$
indicates a partial derivative of Fᵢ(fatturerate (t−1, t, confᵢ) with respect to the variable confᵢ.

29. A first network node configured to facilitate a second network node in paging a user equipment (UE), the first network node comprising:
a processor;
a memory storing instructions which, when executed by the
processor, cause the first network node to:
collect, from one or more network nodes, paging information for the UE;
determining a machine learning (ML) model at least partially based on the paging information; and
transmit, to the second network node, the determined ML model and/or a configuration is derived from the ML model for use by the second network node in paging the UE.

30. A method at a second network node for paging a user equipment (UE), the method comprising:
receiving, from a first network node, a machine learning (ML) model and/or a configuration that is derived from the ML model, for paging the UE;
determining a paging profile at least partially based on the received ML model and/or configuration; and
initiatinga paging procedure for the UE at least partially based on the determined paging profile.

31. The method of claim 30, wherein;
the first network node is a Network Data Analytic Function (NWDAF) that is collocated with the second network node, and the second network node is at least one of:
a Mobility Management Entity (MME);
an Access and Mobility Function (AMF);
a Core Network (CN) node;
a Radio Access Network (RAN) node;
a Packet Core Controller (PCC);
a Packet Core Gateway (PCG);
an Operation Supporting System (OSS);
a Multi-access Edge Computing (MEC) node; and
an O-RAN node; and
the second network node is de oved as a mobility ma ent module at a PCC.

32. (canceled)

33. The method of claim 31, further comprising:
transmitting, to the collocated NWDAF, paging information for the UE;
wherein the paging information comprises at least one of:
location information in terms of tracking area (TA), eNB/qNB, or cell;
time information; and
UE type

34. (canceled)

35. The method of claim 31, further comprising:
receiving, from a network management system, a paging profile for updating the paging profile stored at the second network node.

36. The method of claim 31, wherein;
the NWDAF is deployed as a custom application in a Service Management & Orchestration (SMO) framework at an O-RAN node, and the second network node is a Near-Real Time RAN Intelligent Controller (RIC);
an A1 interface of the O-RAN node is used for exchanging Artificial Intelligence (AD)/ML information and/or information for data analytics; and
the ML model is trained at the Non-Real Time RIC of the O-RAN node, and the trained ML model is passed from the Non-Real Time RIC to the Near-Real Time RIC via the A1 interface.

37. (canceled)

38. (canceled)

39. The method of claim 38, wherein the ML model is trained for extracting at least one of:
network user-level traffic space-time distribution;
user mobility characteristics and/or models;
user service types and/or models; and
user experience prediction models.

40. The method of claim 31, wherein the NWDAF is deployed as an application or service on a MEC platform at a MEC host or collocated with a MEC orchestrator, and the second network node is a User Plane Function (UPF).

41. (canceled)

42. A second network node configured for initiating a paging procedure for a user equipment (UE), the second network node comprising:
a processor
a memory storing instructions which, when executed by the processor, cause the second network node to:
receive, from a first network node, a machine learning (ML) model and/or a configuration that is derevied from the ML model, for paging the UE;
determine a paging profile at leaSt partially based on the received ML model and/or configuration; and
initiate the paging procedure for the UE at least partially based on the determined paging profile.

43. (canceled)

44. (canceled)

45. (canceled)

46. The first network node of claim 29, wherein the first network node is configured to determine the ML model for the UE at least partially based on the paging information by:
training the ML model based on a cost function that is determined at least partially based on an amount of signaling for successfully paging the UE and/or a paging latency.

47. The second network node of claim 42, wherein:
the NWDAF is deployed as a custom application in a Service Management & Orchestration (SMO) framework at an O-RAN node, and the second network node is a Near-Real Time RAN Intelligent Controller (RIC);
an A1 interface of the O-RAN node is used for exchanging Artificial Intelligence (AI)/ML information and/or information for data analytics; and
the ML model is trained at the Non-Real Time RIC of the O-RAN node, and the trained ML model is passed from the Non-Real Time RIC to the Near-Real Time RIC via the A1 interface.
